(19) United States
(12) Patent Application Publication
(10) Pub. No.: US 2026/0124538 A1
(43) Pub. Date: May 7, 2026

(54) METHOD AND DEVICE FOR INTERACTIVE PROCESSING IN VIRTUAL SCENE, AND STORAGE MEDIUM

(71) Applicant: Hangzhou Pawprint Interactive Entertainment Technology Co., Ltd., Hangzhou (CN)

(72) Inventor: Yingwu ZHONG, Hangzhou (CN)

(21) Appl. No.: 19/330,675

(22) Filed: Sep. 16, 2025

(30) Foreign Application Priority Data
Nov. 4, 2024 (CN) 202411557697.2

(51) Int. Cl. A63F 13/55; A63F 13/825; G06F 3/0482

(52) U.S. Cl. CPC A63F 13/55; A63F 13/825; G06F 3/0482

(57) ABSTRACT

A method and a device for interactive processing in virtual scene are provided. The method includes the following operations. The virtual scene is displayed in a human-computer interaction interface, and the virtual scene includes a first player character. In response to a fusion triggering operation for the first player character and at least one first virtual pet of the first player character, or in response to the first player character and the at least one first virtual pet of the first player character meeting an automatic fusion condition, the first player character is fused with the at least one first virtual pet to form a second virtual pet. In response to an interactive triggering operation for the second virtual pet, the second virtual pet is controlled to release a skill of the first virtual pet.

### CROSS-REFERENCE TO RELEVANT APPLICATION

The present disclosure claims priority to Chinese patent application No. 202411557697.2 filed on November 4, 2024, the contents of which are hereby incorporated by reference in its entirety.

### BACKGROUND

In the field of game technologies, in order to optimize a user interactive experience, many game developers create a virtual environment that is both realistic and interesting, allowing a player character to have a rich and diverse interactive experience with a virtual pet. In the related art, an interaction mode between the player character and the virtual pet is too monotonous, lacking a deep interaction with the virtual pet, which affects the immersion of the player character during an interactive process.

### SUMMARY

The present disclosure relates to computer technologies, and more particularly to a method and device for interactive processing in a virtual scene. The embodiments of the present disclosure provide a method and a device for interactive processing in a virtual scene, an electronic device, a computer-readable storage medium and a computer program product, which is capable of providing a variety of interaction modes and improving a gaming experience of a player.

The technical solutions of the embodiments of the present disclosure are implemented as follows.

According to a first aspect of the disclosure, an embodiment of the present disclosure provides a method for interactive processing in a virtual scene, which includes the following operations.

The virtual scene is displayed in a human-computer interaction interface, and the virtual scene includes a first player character.

In response to a fusion triggering operation for the first player character and at least one first virtual pet of the first player character, or in response to the first player character and the at least one first virtual pet of the first player character meeting an automatic fusion condition, the first player character is fused with the at least one first virtual pet to form a second virtual pet, and the first player character is a player character controlled by the human-computer interaction interface.

In response to an interactive triggering operation for the second virtual pet, the second virtual pet is controlled to release a skill of the first virtual pet, an interactive target of the skill includes at least one of: a non-player character in the virtual scene, or a second player character in the virtual scene, and the second player character is different from the first player character.

According to a second aspect of the disclosure, an embodiment of the present disclosure provides a device for interactive processing in a virtual scene, which includes a scene display module, a fusion processing module and a control processing module.

The scene display module is configured to display the virtual scene in a human-computer interaction interface. The virtual scene includes a first player character.

The fusion processing module is configured to: in response to a fusion triggering operation for the first player character and at least one first virtual pet of the first player character, or in response to the first player character and the at least one first virtual pet of the first player character meeting an automatic fusion condition, fuse the first player character with the at least one first virtual pet to form a second virtual pet. The first player character is a player character controlled by the human-computer interaction interface.

The control module is configured to: in response to an interactive triggering operation for the second virtual pet, control the second virtual pet to release a skill of the first virtual pet. An interactive target of the skill includes at least one of: a non-player character in the virtual scene, or a second player character in the virtual scene, and the second player character is different from the first player character.

According to a third aspect of the disclosure, an embodiment of the present disclosure provides a computer-readable storage medium. The computer-readable storage medium is configured to store computer programs or computer-executable instructions. The computer programs or the computer-executable instructions, when executed by a processor, implement the method for interactive processing in a virtual scene provided by the embodiments of the present disclosure.

### BRIEF DESCRIPTION OF THE DRAWINGS

FIG. 1 is a schematic diagram illustrating an architecture of an interactive processing system 100 for virtual scene according to an embodiment of the present disclosure.

FIG. 2 is a schematic diagram illustrating a structure of a terminal 400 according to an embodiment of the present disclosure.

FIG. 3A is a first flowchart illustrating a method for interactive processing in a virtual scene according to an embodiment of the present disclosure.

FIG. 3B is a second flowchart illustrating a method for interactive processing in a virtual scene according to an embodiment of the present disclosure.

FIG. 3C is a third flowchart illustrating a method for interactive processing in a virtual scene according to an embodiment of the present disclosure.

FIG. 3D is a fourth flowchart illustrating a method for interactive processing in a virtual scene according to an embodiment of the present disclosure.

FIG. 3E is a fifth flowchart illustrating a method for interactive processing in a virtual scene according to an embodiment of the present disclosure.

FIG. 3F is a sixth flowchart illustrating a method for interactive processing in a virtual scene according to an embodiment of the present disclosure.

FIG. 4A is a first schematic diagram illustrating a virtual scene according to an embodiment of the present disclosure.

FIG. 4B is a second schematic diagram illustrating a virtual scene according to an embodiment of the present disclosure.

FIG. 4C is a third schematic diagram illustrating a virtual scene according to an embodiment of the present disclosure.

FIG. 4D is a fourth schematic diagram illustrating a virtual scene according to an embodiment of the present disclosure.

FIG. 5A is a fifth schematic diagram illustrating a virtual scene according to an embodiment of the present disclosure.

FIG. 5B is a sixth schematic diagram illustrating a virtual scene according to an embodiment of the present disclosure.

FIG. 5C is a seventh schematic diagram illustrating a virtual scene according to an embodiment of the present disclosure.

FIG. 5D is an eighth schematic diagram illustrating a virtual scene according to an embodiment of the present disclosure.

FIG. 5E is a ninth schematic diagram illustrating a virtual scene according to an embodiment of the present disclosure.

FIG. 5F is a tenth schematic diagram illustrating a virtual scene according to an embodiment of the present disclosure.

FIG. 6A is an eleventh schematic diagram illustrating a virtual scene according to an embodiment of the present disclosure.

FIG. 6B is a twelfth schematic diagram illustrating a virtual scene according to an embodiment of the present disclosure.

FIG. 6C is a thirteenth diagram illustrating a virtual scene according to an embodiment of the present disclosure.

FIG. 6D is a fourteenth schematic diagram illustrating a virtual scene according to an embodiment of the present disclosure.

It should be noted that “first” and “second” mentioned above are only used to distinguish different solutions and do not represent superiority or inferiority of the solutions or their priorities during an implementation process.

### DETAILED DESCRIPTION

To make the objectives, technical solutions and advantages of the present disclosure clearer, a further detailed description of the present disclosure will be provided below in combination with the accompanying drawings. The embodiments described should not be regarded as limitations to the present disclosure. All other embodiments obtained by an ordinary skilled person in the art without creative effort fall within the scope of protection of the present disclosure.

In the following description, the expression “some embodiments” describes a subset of all possible embodiments. However, it should be understood that “some embodiments” may be a same subset or different subsets of all possible embodiments and may be combined with each other without conflict.

The term “first/second/third” involved in the following description is merely used to distinguish similar objects and does not represent a particular ordering of objects. It should be understood that “first/second/third” may be interchanged in a particular order or sequence, so that the embodiments of the present disclosure described herein can be implemented in an order other than that illustrated or described herein.

In the embodiments of the present disclosure, the term “module” or “unit” refers to a computer program with a predefined function or a part of the computer program, which works with other related parts to achieve a predefined goal and can be implemented in whole or in part by using software, hardware (such as a processing circuit or memory), or a combination thereof. Similarly, one processor (or multiple processors or memories) may be configured to implement one or more modules or units. In addition, each module or unit can be a part of an overall module or unit that includes the functions of the module or unit.

Unless otherwise specified, the term “at least one” as used herein refers to one or more instances, and the term “multiple/plurality” refers to two or more instances.

Unless otherwise defined, all technical and scientific terms used in the embodiments of the present disclosure have the same meaning as that commonly understood by those skilled in the art. The terms used herein are merely intended to describe the embodiments of the present disclosure and are not intended to limit the present disclosure.

During example application of the relevant data collection and processing in the embodiments of the present disclosure, the informed consent or individual consent of a personal information subject needs to be obtained in strict accordance with the requirements of relevant laws and regulations, and the subsequent data use and processing behavior is carried out within the scope of authorization of laws and regulations and the personal information subject.

Before the embodiments of the present disclosure are further described in detail, a description is made on nouns and terms in the embodiments of the present disclosure, and the nouns and terms in the embodiments of the present disclosure are applicable to the following explanations.

1) In response to: It is used to indicate a condition or state on which the operation being performed depends. When the dependent condition or state is met, one or more operations to be performed may be in real time or have a set delay. Unless otherwise specified, there is no restriction on an order of execution for multiple operations.

2) Human-computer interaction interface: It is used to provide an interface with a human-computer interactive function. For example, displaying a graphical user interface (GUI) such as an augmented reality (AR) interface, a virtual reality (VR) interface, a voice user interface (VUI), an interactive projection interface (displaying information on a plane using a projection technology), an eye-tracking interface (controlling the interface by detecting the user's line of sight), a holographic interface (a three-dimensional hologram image is formed by projecting an image using a holographic projection technology, which can be viewed as a stereoscopic image without wearing special glasses), a multimodal interface (an interaction interface that combines multiple interaction modes such as tactile, visual, or auditory), a brain-machine interface (BMI), and/or the like.

3) Virtual scene (or called virtual environment): It is a scene that is displayed (or provided) by an application when running on a terminal device. The scene may be a simulated environment of the real world, a semi-simulated and semi-fictional virtual environment, or a purely fictional virtual environment. A player can control movement of a player character in the virtual scene. For example, in a game scene, the virtual scene may be a scene of a game match.

4) Player character: It is a virtual character directly controlled by the player in an online game, a video game, or other virtual scenes, which is used to interact with other player characters or non-player characters in the virtual scene.

5) Virtual pet: It refers to a character designed in a video game or online game to simulate a real pet. For example, the real pet may be a digital pet that the player may raise, train, and interact with, or a virtual pet that collaborates with the player character to complete a preset task.

6) Historical summoning frequency: It refers to a frequency or the number of times that a player character summons the virtual pet into the virtual scene in a preset historical period. For example, if the player character summons a virtual pet A into the virtual scene five times in a one-month period ending at a current moment, then the historical summoning frequency for the virtual pet A is five times per month.

In the related art, an interaction mode between the player character and the virtual pet is too monotonous, lacking a deep physical or emotional interaction with the virtual pet, thereby affecting the immersion of the player character during an interactive process.

Based on above analysis, the applicant found that the interactive processing method in the virtual scene of the related art could not provide a variety of interaction modes, resulting in a poor gaming experience for the player. For the above problem, the present disclosure provides a method and a device for interactive processing in virtual scene, an electronic device, a computer-readable storage medium and a computer program product, which is capable of providing a variety of interaction modes and improving the gaming experience of the player.

An exemplary application of the electronic device provided by the embodiments of the present disclosure is described below. The electronic device provided by the embodiments of the present disclosure may be implemented as various types of terminals, such as laptops, tablet computers, desktop computers, set-top boxes, smartphones, smart speakers, smart watches, smart TVs, and in-vehicle terminals; and may also be implemented as a server. The exemplary application of the electronic device implemented as the terminal will be described below.

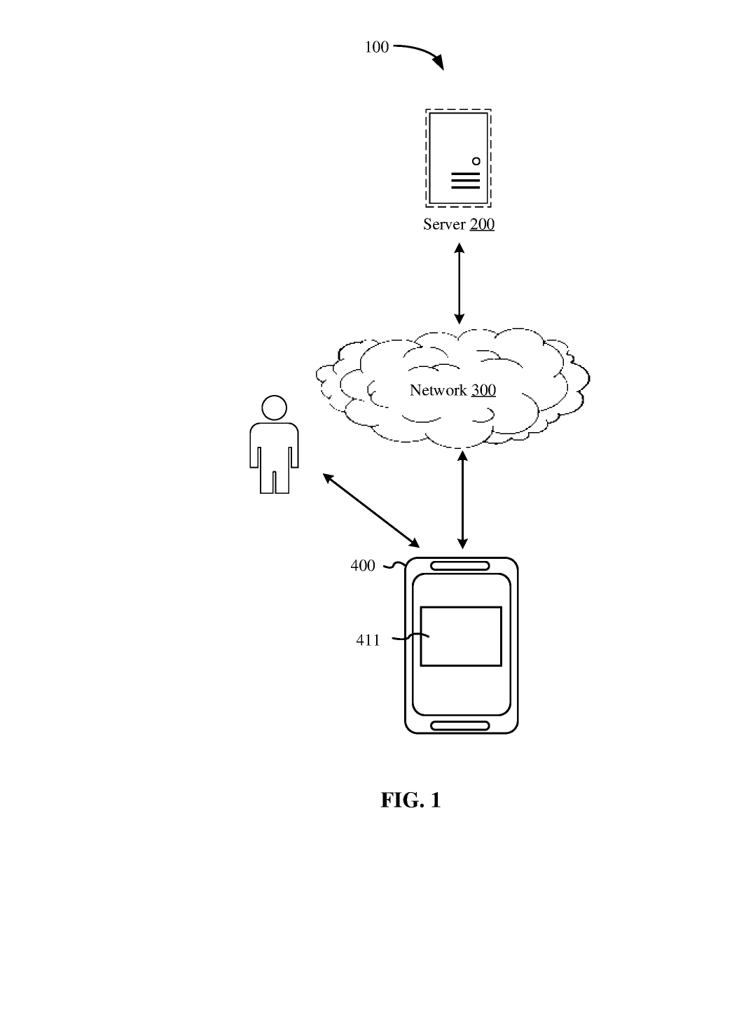

Referring to FIG. 1, FIG. 1 is a schematic diagram illustrating an architecture of an interactive processing system 100 for virtual scene according to an embodiment of the present disclosure. To support an interactive processing application for a virtual scene, a terminal 400 (illustrating a human-computer interaction interface 411) is connected to a server 200 via a network 300. The network 300 may be a wide area network, a local area network, or a combination of the wide area network and the local area network.

The terminal 400 is configured to display a virtual scene in the human-computer interaction interface 411. When detecting a fusion triggering operation for the first player character and at least one first virtual pet of the first player character, or when the first player character and the at least one first virtual pet of the first player character meet an automatic fusion condition, the first player character is fused with the at least one first virtual pet to form a second virtual pet. When an interactive triggering operation for the second virtual pet is detected, the second virtual pet is controlled to release a skill of the first virtual pet, so as to interact with other player characters or non-player characters in the virtual scene.

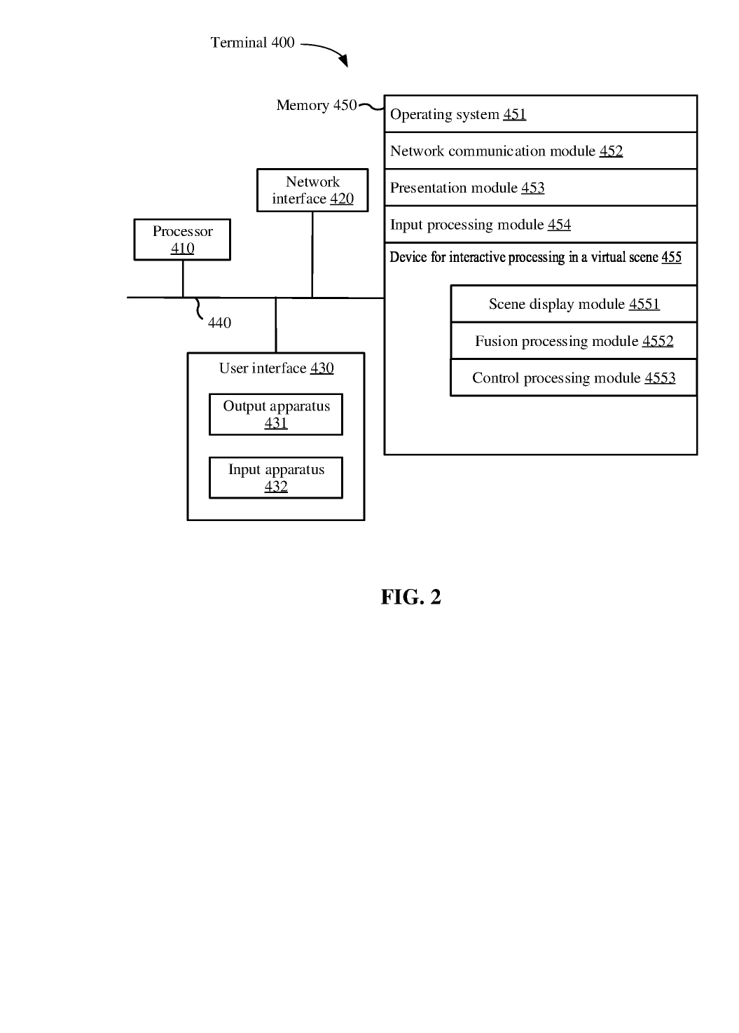

Referring to FIG. 2, FIG. 2 is a schematic diagram illustrating a structure of a terminal 400 according to an embodiment of the present disclosure. The terminal 400 illustrated in FIG. 2 includes at least one processor 410, a memory 450, at least one network interface 420 and a user interface 430. The components of the electronic device 400 are coupled together through a bus system 440. It should be understood that the bus system 440 is configured to implement communication connection among these components. In addition to a data bus, the bus system 440 further includes a power bus, a control bus, and a status signal bus. However, for the sake of clarity, all types of buses are labeled as the bus system 440 in FIG. 2.

The processor 410 may be an integrated circuit chip that has a capability for processing signals, such as a general-purpose processor, a digital signal processor (DSP), or another programmable logical device, a discrete gate or transistor logical device, a discrete hardware component or the like. The general-purpose processor may be a microprocessor or any conventional processor.

The user interface 430 includes one or more output apparatuses 431 that enable presentation of media content, including one or more speakers and/or one or more visual display screens. The user interface 430 further includes one or more input apparatuses 432, including a user interface component that facilitates user inputs, such as a keyboard, a mouse, a microphone, a touchscreen display, a camera, and other input buttons and controls.

The memory 450 may be a removable memory, a non-removable memory, or a combination thereof. An exemplary hardware device includes a solid-state memory, a hard disk drive, an optical disc drive, and the like. The memory 450 optionally includes one or more storage devices physically located away from the processor 410.

The memory 450 includes a volatile memory or a non-volatile memory, or may include both a volatile memory and a non-volatile memory. The non-volatile memory may be a read-only memory (ROM), and the volatile memory may be a random access memory (RAM). The memory 450 described in the embodiments of the present disclosure is intended to include any suitable type of memory.

In some embodiments, the memory 450 is capable of storing data to support various operations. Examples of the data include a program, a module, and a data structure or a subset or superset thereof, which are described below by using examples.

An operating system 451 includes system programs for processing various basic system services and performing hardware-related tasks, such as a framework layer, a core library layer, and a driver layer, and is used for implementing various basic services and processing hardware-based tasks.

A network communication module 452 is configured to reach other electronic devices via one or more (wired or wireless) network interfaces 420. Exemplarily, the network interfaces 420 include Bluetooth, wireless fidelity (WiFi), a universal serial bus (USB), and the like.

A presentation module 453 is configured to present information via one or more output apparatuses 431 (such as a display screen and a speaker) associated with the user interface 430 (for example, a user interface for operating a peripheral device and displaying content and information).

An input processing module 454 is configured to detect one or more user inputs or interaction from one of the one or more input apparatuses 432, and translate the detected inputs or interaction.

In some embodiments, the device provided by the embodiments of the present disclosure may be implemented in a software manner. FIG. 2 illustrates a device for interactive processing in a virtual scene 455 stored in the memory 450, which may be software in a form of a program or a plugin, including the following software modules: a scene display module 4551, a fusion processing module 4552, and a control processing module 4553. These modules are logical and thus may be combined or further divided arbitrarily according to functions to be implemented. Functions of each module will be described below.

In some embodiments, the terminal or server may implement the method for interactive processing in the virtual scene provided by the embodiments of the present disclosure by running various computer-executable instructions or computer programs. For example, the computer-executable instruction may be a microprogram-level instruction, a machine instruction, or a software instruction. The computer program may be a native program or a software module in the operating system, may be a native application (APP), to be specific, a program that needs to be installed in the operating system to run, for example, a game APP, or may be an applet that can be embedded into any APP, to be specific, a program that only needs to be downloaded into a browser environment to run. Based on the above, the foregoing computer-executable instruction may be an instruction of any form. The foregoing computer program may be an APP, a module, or a plug-in of any form.

The method for interactive processing in virtual scene provided by the embodiments of the present disclosure will be described below in conjunction with an example application and implementation of the terminal provided by the embodiments of the present disclosure.

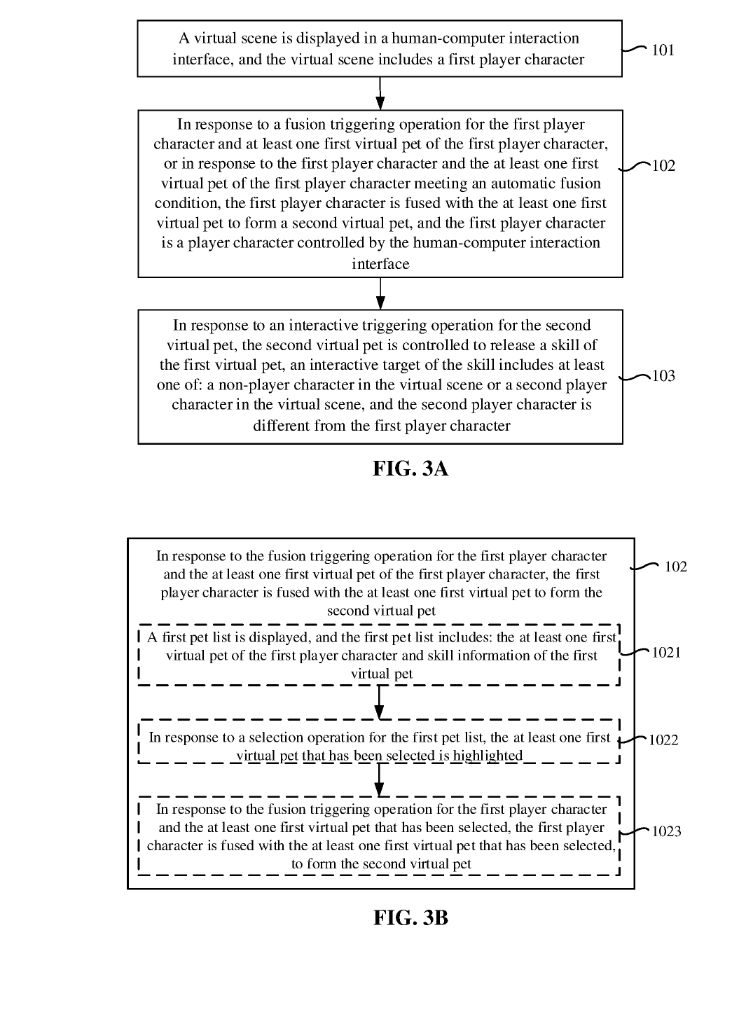

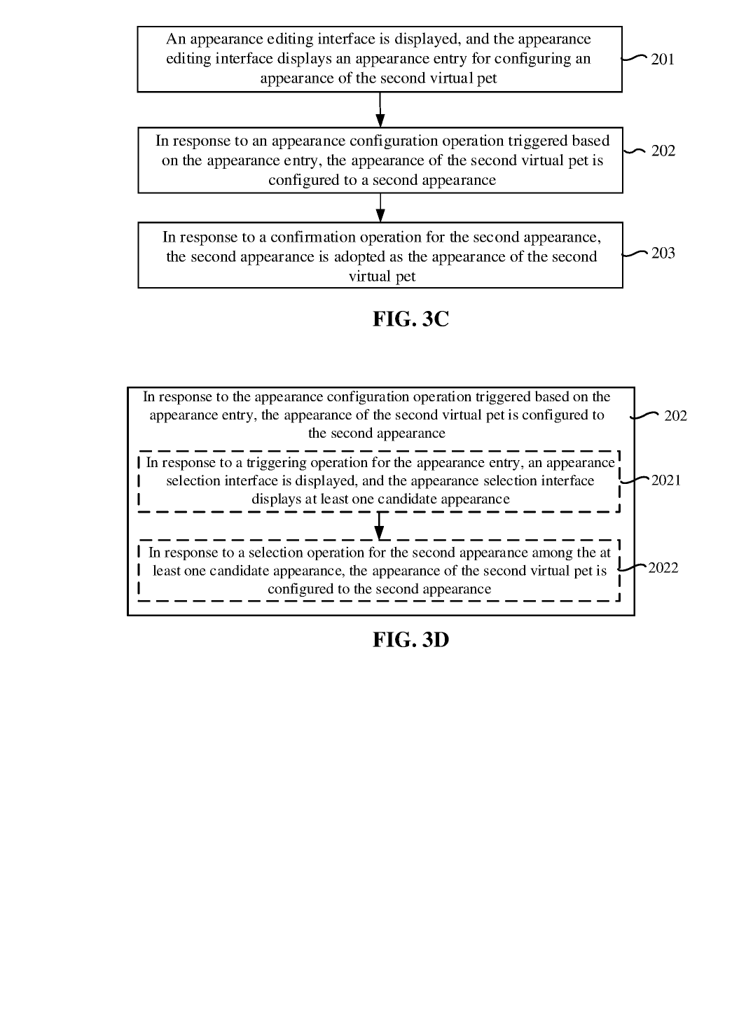

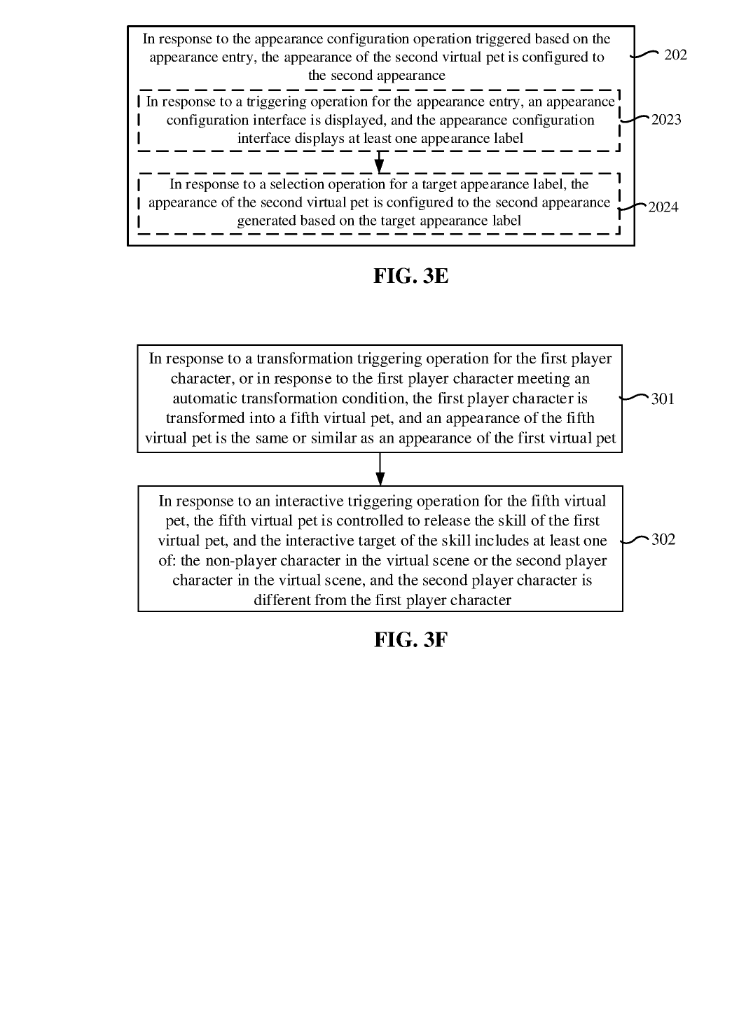

Referring to FIG. 3A, FIG. 3A is a first flowchart illustrating a method for interactive processing in a virtual scene according to an embodiment of the present disclosure, with a terminal as an execution subject. The following describes the method with reference to the operation 101 to operation 103 illustrated in FIG. 3A.

In operation 101, a virtual scene is displayed in a human-computer interaction interface, and the virtual scene includes a first player character.

In some embodiments, the virtual scene may be displayed in the human-computer interaction interface of the terminal, and the first player character is displayed in the virtual scene. The first player character may be a player character controlled by a user of the terminal. For example, the virtual scene can be displayed in the human-computer interaction interface 411 of terminal 400 illustrated in FIG. 1. The first player character and skill information of the first player character are displayed in virtual scene.

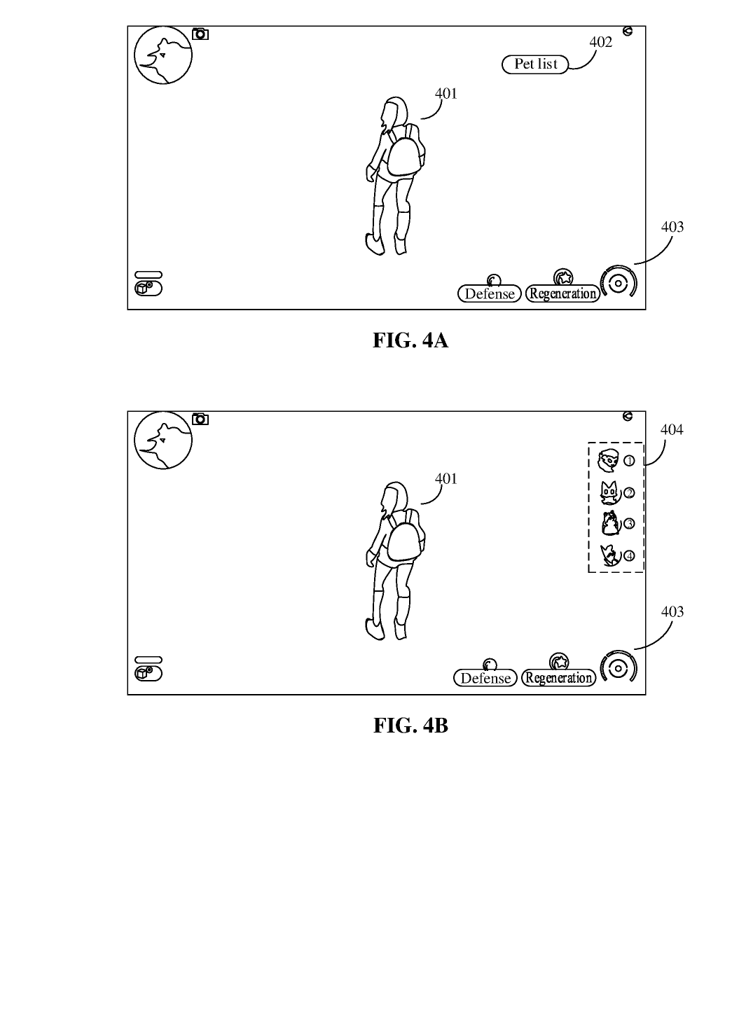

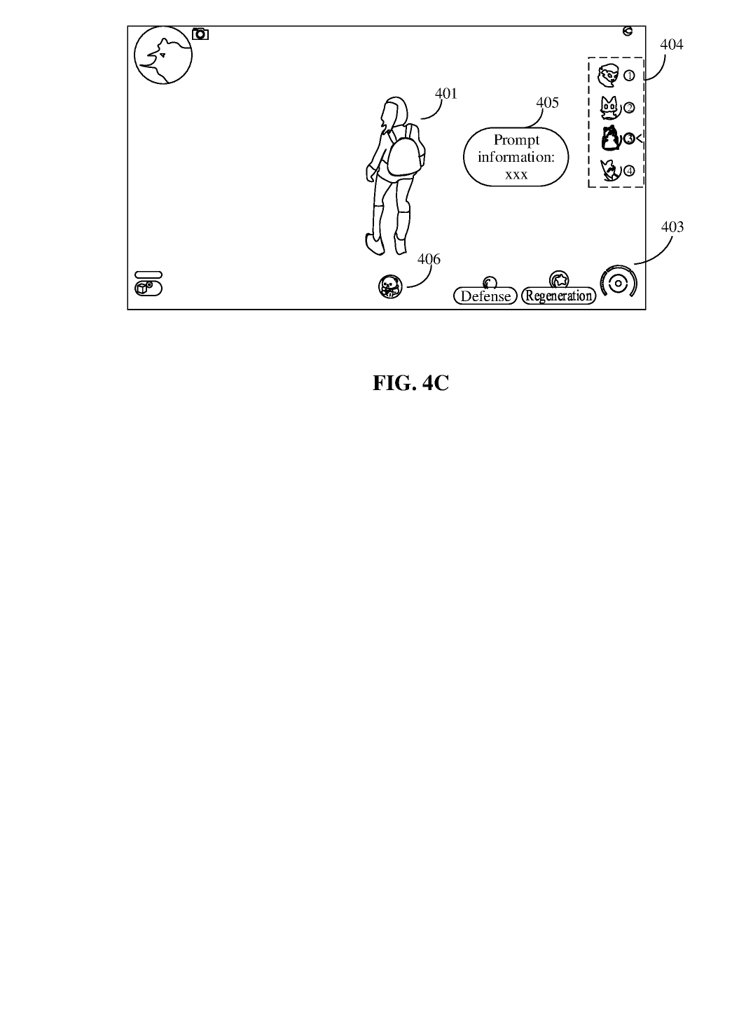

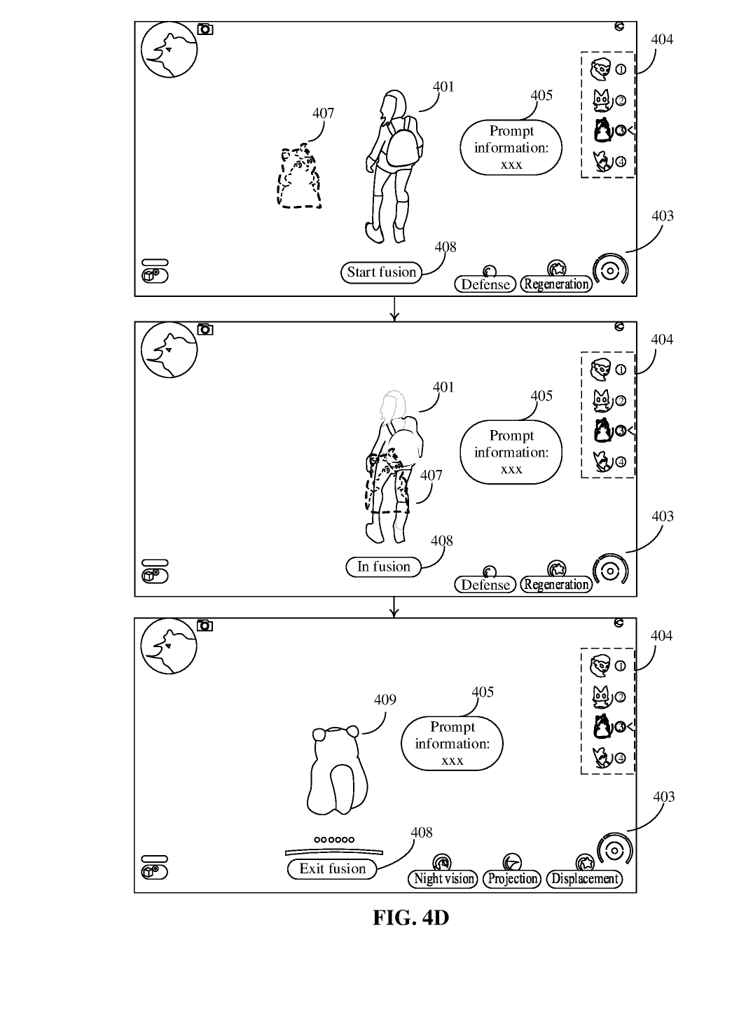

For example, referring to FIG. 4A, FIG. 4A is a first schematic diagram illustrating a virtual scene according to an embodiment of the present disclosure. As illustrated in FIG. 4A, a first player character 401 is displayed in the virtual scene of the human-computer interaction interface.

In operation 102, in response to a fusion triggering operation for the first player character and at least one first virtual pet of the first player character, or in response to the first player character and the at least one first virtual pet of the first player character meeting an automatic fusion condition, the first player character is fused with the at least one first virtual pet to form a second virtual pet. The first player character is a player character controlled by the human-computer interaction interface.

In some embodiments, in response to the fusion triggering operation for the first player character and at least one first virtual pet of the first player character, the first player character is fused with the at least one first virtual pet to form the second virtual pet. The first player character is the player character controlled by the human-computer interaction interface.

In some embodiments, in response to the first player character and the at least one first virtual pet of the first player character meeting an automatic fusion condition, the first player character is fused with the at least one first virtual pet to form the second virtual pet, and the first player character is the player character controlled by the human-computer interaction interface.

Herein, the number of the first virtual pets fusing with the first player character to form the second virtual pet can be one or more, which can be set by the player in a setting interface during a game process, or can be uniformly preset by a game developer in a game system before the game starts. At least one first virtual pet can be a virtual pet that is not displayed in the current virtual scene, or can be a virtual pet that is displayed in the current virtual scene following the first player character.

In some embodiments, the automatic fusion condition includes any one of: condition 1, condition 2, condition 3, or condition 4.

Condition 1: A matching degree of the at least one the first virtual pet with a current environment in which the first player character is located and the interactive target is greater than a matching degree of the first player character with the current environment and the interactive target.

For example, if it is relatively difficult for the first player character to complete a target task or reach an interactive target in the current environment relying on its own skill, but it is relatively easy to complete the target task or reach the interactive target in the current environment based on the skill of at least one first virtual pet, then it is considered that the matching degree of the at least one the first virtual pet with the current environment in which the first player character is located and the interactive target is greater than the matching degree of the first player character with the current environment and the interactive target.

Condition 2: The at least one first virtual pet is a first pre-configured object for the interactive target. The first pre-configured object is a virtual pet that automatically fuses with the first player character when a distance between the first player character and the interactive target is less than a distance threshold.

In some embodiments, at least one first virtual pet for the interactive target can be determined based on the distance between the first player character and the interactive target. For example, when the distance between the first player character and the interactive target is 5 meters and the distance threshold is 10 meters, an automatic fusion of the at least one first virtual pet with the first player character is triggered.

Condition 3: The at least one first virtual pet is a second pre-configured object for the current environment in which the first player character is located. The second pre-configured object is a virtual pet that automatically fuses with the first player character when the first player character is located in the current environment.

In some embodiments, at least one first virtual pet can be determined based on the current environment in which the first player character is located. For example, if the current environment in which the first player character is located, is a turbulent river, and the first player character needs to cross the river, a virtual pet with the ice attribute can be pre-configured so that the first player character can control the virtual pet to freeze the water surface into ice blocks, thus facilitating the first player character to cross the river.

Condition 4: A skill of the first player character alone is not capable of implementing a preset interactive result with the interactive target, and the skill of the at least one first virtual pet is capable of implementing the preset interactive result with the interactive target.

Here, the preset interactive result can be defeating an opponent in a confrontation scene. The preset interactive result can also be completing a specific task in a collaborative scene.

In some embodiments, referring to FIG. 3B, FIG. 3B is a second flowchart illustrating a method for interactive processing in a virtual scene according to an embodiment of the present disclosure. “In response to the fusion triggering operation for the first player character and the at least one first virtual pet of the first player character, the first player character is fused with the at least one first virtual pet to form the second virtual pet” in operation 102 above can be achieved by performing operation 1021 to operation 1023 in FIG. 3B, as described below.

In operation 1021, a first pet list is displayed, and the first pet list includes: the at least one first virtual pet of the first player character and skill information of the first virtual pet.

In some embodiments, a first pet list control may be displayed in the human-computer interaction interface. In response to a triggering operation for the first pet list control, the first pet list is displayed. Here, the at least one first virtual pet in the first pet list can be presented in the form of a name, an avatar, and/or the like. The skill information of the first virtual pet includes an introduction to each skill of the first virtual pet to assist the first player character in selecting a suitable first virtual pet.

As an example, with continued reference to FIG. 4A, a first pet list control 402 and a skill combination 403 of the player character 401 are displayed in the human-computer interaction interface illustrated in FIG. 4A. The skill combination 403 displays a defense skill, a regeneration skill, and a normal attack skill. In response to the triggering operation for the first pet list control 402, the human-computer interaction interface illustrated in FIG. 4B is displayed. FIG. 4B is a second schematic diagram illustrating a virtual scene according to an embodiment of the present disclosure. FIG. 4B illustrates the player character 401, the skill combination 403 of the player character 401 and the first pet list 404. The first pet list 404 displays four virtual pets, each corresponding to a number and an avatar of a respective virtual pet.

In some embodiments, when the number of first virtual pets in the first pet list is multiple, the multiple first virtual pets are sorted based on at least one of the following characteristic parameters: a historical summoning frequency, a historical fusion frequency, a matching degree with at least one of: a current environment in which the first player character is located or the interactive target, or an attribute value of the skill of the first virtual pet.

Here, the multiple first virtual pets are sorted based on at least one of the above characteristic parameters. Specifically, the multiple first virtual pets can be sorted based on a single characteristic parameter (in ascending or in descending order). Alternatively, the multiple first virtual pets can be sorted based on a result obtained from a weighted sum of parameter values of multiple characteristic parameters. Here, the weight of each characteristic parameter can be an average weight, a personalized weight set by the player according to their needs, or a weight determined based on an attention mechanism. The historical summoning frequency refers to a frequency or the number of times that the first player character summons a virtual pet into the virtual scene in a preset historical period. For example, if the player character summons a virtual pet A into the virtual scene five times in a one-month period ending at a current moment, then the historical summoning frequency for the virtual pet A is five times per month. The attribute value of the skill of the first virtual pet can include attack power, defense power, speed, stamina, magic points, and/or the like.

In some embodiments, the matching degree of the first virtual pet with the at least one of the current environment in which the first player character is located or the interactive target is determined based on the following approaches. One approach is that, in the confrontation scene, a probability of the first virtual pet and the first player character defeating the interactive target in the current confrontation environment is determined, where the greater the probability, the greater matching degree. The other approach is that, in the collaborative scene, a probability of the first virtual pet and the first player character collaborating with the interactive target (to achieve a task objective) is determined, where the greater the probability, the greater matching degree.

When the number of first virtual pets in the first pet list is multiple, the multiple first virtual pets are sorted based on a variety of different characteristic parameters. The multiple first virtual pets are sorted based on the historical summoning frequency and the historical fusion frequency, which can help the player quickly find their most frequently used pet, thereby improving an operational efficiency and a gaming experience. The multiple first virtual pets are sorted based on the current environment in which the player character is located and interactive target player, which enables it easier for the player to select the most suitable pet for the current environment, thereby increasing the strategy and immersion of the game. The game can intelligently recommend the pet based on the player's needs and the game strategy by taking into account the attribute values of the skill of the pet and their compatibility with the player character, eliminating the need for the player to screen numerous pets one by one. In summary, the above sorting mechanism can help the player make a decision quickly, allowing the user to select a best pet combination for combat and task completion based on the sorting result, thereby enhancing the tactical depth to the game. When the game environment shifts, the player can promptly adjust the pet configuration to meet new challenges. Sorting virtual pets in this manner can improve the operational efficiency of the player, enrich game strategies, increase the fun and playability of the game, and also help with the data analysis and balance adjustment of the game.

In some embodiments, the matching degree is predicted by using a first machine learning model based on a characteristic of the first player character, a characteristic of the current environment in which the first player character is located, and a characteristic of the interactive target. The first machine learning model is trained by: calculating a predicted matching degree using the first machine learning model based on a characteristic of a sample player character, a characteristic of a current environment in which the sample player character is located, and a characteristic of an interactive target of the sample player character; and back-propagating a difference between the predicted matching degree and an actual interactive result label to update a parameter of the first machine learning model.

Here, the characteristic of the first player character can be the attribute value of various skills that the first player character itself possesses (e.g., attack power, defense power, speed, stamina, magic points, and/or the like). The characteristic of the current environment in which the first player character is located can include a type of the environment (enclosed type, or open type) and an area of the environment. The characteristic of the interactive target can be the attribute value of the interactive target (e.g., attack power, defense power, speed, stamina, magic points, and/or the like), the quantity and the location of the interactive target(s).

In some embodiments, the matching degree can be predicted by the terminal or the server using the first machine learning model based on the characteristic of the first player character, the characteristic of the current environment in which the first player character is located, and the characteristic of the interactive target. The first machine learning model mentioned above can be trained in the following way. Firstly, the predicted matching degree is calculated by using the first machine learning model based on the characteristic of the first player character, the characteristic of the current environment in which the first player character is located, and the characteristic of the interactive target; and then the difference between the predicted matching degree and the actual interactive result label (1 for a match, 0 for no match) is back-propagated by using a backpropagation algorithm and based on a loss value (the loss value is determined by using a loss function), so as to update parameters of the first machine learning model.

As an example, the first machine learning model may be a multilayer perceptron (MLP) or a convolutional neural network (CNN), a recurrent neural network (RNN), a variational autoencoder (VAE), a transformer, a long short-term memory network (LSTM), a proximal policy optimization (PPO), or the like. The loss function used to determine the loss value may be a mean squared error (MSE), a root mean squared error (RMSE), a mean absolute error loss (MAE), a cross-entropy loss, or other loss functions.

In the embodiments of the present disclosure, the matching degree of the first pet with at least one of: the current environment in which the first player character is located or the interactive target is predicted by using the first machine learning model, so that more personalized pet recommendations can be provided for the player based on a behavior pattern, a preference, and historical data of the player, which may help the player quickly find the most suitable virtual pet for the current game environment, thereby enhancing the dynamism and adaptability of the game and making the gaming experience more coherent. As a result, the gaming experience and player satisfaction are improved.

In operation 1022, in response to a selection operation for the first pet list, the at least one first virtual pet that has been selected is highlighted.

In some embodiments, in response to the selection operation for the first pet list, in addition to highlighting the at least one first virtual pet that has been selected, prompt information may also be displayed to prompt a virtual pet with the same or similar skill as the first virtual pet, or prompt a virtual pet that frequently (i.e., with a frequency higher than a frequency threshold) fuses with the first player character together with the selected first virtual pet.

As an example, with continued reference to FIG. 4B, the human-computer interaction interface is displayed illustrated in FIG. 4C in response to a click operation of the player for the third virtual pet in the first pet list 404. FIG. 4C is a third schematic diagram illustrating a virtual scene according to an embodiment of the present disclosure. As illustrated in FIG. 4C, the third virtual pet in the first pet list 404 is displayed in bold, and prompt information 405 is also displayed simultaneously.

In operation 1023, in response to the fusion triggering operation for the first player character and the at least one first virtual pet that has been selected, the first player character is fused with the at least one first virtual pet that has been selected, to form the second virtual pet.

In some embodiments, the fusion triggering operation for the first player character and the at least one first virtual pet (that has been selected) may take various forms. For example, the fusion triggering operation could be a triggering operation for a fusion control in the human-computer interaction interface, or a fusion operation in the form of voice control, motion-sensing control, or the like.

As an example, with continued reference to FIG. 4C, the human-computer interaction interface in FIG. 4C displays a fusion control 406. In response to the triggering operation for the fusion control 406, the human-computer interaction interface illustrated in FIG. 4D is displayed. FIG. 4D is a fourth schematic diagram illustrating a virtual scene according to an embodiment of the present disclosure. As illustrated in the human-computer interaction interface at the top of FIG. 4D, a third virtual pet 407 from the first pet list 404 is displayed, together with a fusion state control 408, at this time, a fusion state displayed in the fusion state control 408 is starting fusion. During the fusion process, the first player character and the virtual pet 407 gradually fuse. As illustrated in the human-computer interaction interface in the middle of FIG. 4D, at this time, the fusion state displayed in the fusion state control 408 is in fusion. Finally, the human-computer interaction interface at the bottom of FIG. 4D is displayed. The human-computer interaction displays a second virtual pet 409 formed by the fusion of the first player character 401 and the virtual pet 407. At this time, the fusion state displayed in the fusion state control 408 is exiting fusion, indicating that the fusion is completed, and the attribute value of the second virtual pet 409 is displayed simultaneously. The skills in the skill combination 403 are updated to skills of the second virtual pet 409.

In some embodiments, “in response to the fusion triggering operation for the first player character and the at least one first virtual pet of the first player character, the first player character is fused with the at least one first virtual pet to form the second virtual pet” in operation 102 above can also be achieved by: displaying a skill list control in the human-computer interaction interface, displaying a skill list in response to a triggering operation for the skill list control, displaying a first virtual pet with a corresponding skill in response to a selection operation for any skill in the skill list, highlighting at least one first virtual pet that has been selected in response to a selection operation for the first virtual pet with the corresponding skill, and fusing the first player character and the at least one first virtual pet (that has been selected) to form the second virtual pet in response to a fusion trigger operation for the first player character and the at least one first virtual pet that has been selected.

The solution “in response to the fusion triggering operation for the first player character and the at least one first virtual pet of the first player character, the first player character is fused with the at least one first virtual pet to form the second virtual pet” in operation 102 of the embodiments of the present disclosure may be used in a virtual scene excluding a virtual pet, and also be used in a virtual scene including a virtual pet that does not need to be fused. The virtual pet can be quickly summoned for fusion by performing the above processing. That is, there is no need to firstly summon the virtual pet into the virtual scene and then fuse the player character with the virtual pet, which can improve the operational efficiency of the player during the game and enhance the gaming experience.

Here, the number of first virtual pets following the first player character at the same time can be one or more, and the number of first virtual pets following can be preset by the game developer in a game background system or set by the first player character.

In some embodiments, before performing “in response to the fusion triggering operation for the first player character and the at least one first virtual pet of the first player character” in operation 102, when the virtual scene also includes the at least one first virtual pet for the first player character, and the first player character has multiple first virtual pets, at least one of the following processes may be performed. A second pet list is displayed, the second pet list includes the multiple first virtual pets belonging to the first player character (indicated by name, avatar, etc.). In response to a selection operation for the second pet list, a first virtual pet following the first player character in the virtual scene is switched to a selected first virtual pet. In response to a switching operation, a first virtual pet currently following the first player character is switched to another first virtual pet of the first virtual player. Here, the other first virtual pet is the first virtual pet with a highest screening parameter among the multiple first virtual pets, and the screening parameter is determined based on at least one of: a historical summoning frequency (i.e., a frequency or the number of times that the first player character summons a virtual pet into the virtual scene), a historical fusion frequency, a matching degree with a current environment in which the first player character is located and the interactive target, or an attribute value of the skill of the first virtual pet (e.g., attack power, defense power, speed, stamina, magic points, and/or the like).

In some embodiments, “in response to the first player character and the at least one first virtual pet of the first player character meeting the automatic fusion condition, the first player character is fused with the at least one first virtual pet to form the second virtual pet” in operation 102 above, the automatic fusion function, that fuses the first player character with the at least one first virtual pet to form the second virtual pet based on the automatic fusion condition, can be achieved by setting in a game set-up system, for example, by providing a switch control in a game setup interface for the player character to select whether to activate the automatic fusion function.

In some embodiments, when the virtual scene currently only includes at least one first virtual pet of the first player character, the first player character is fused with the at least first virtual pet currently included in the virtual scene, to form the second virtual pet. In this case, “the first player character is fused with the at least one first virtual pet to form the second virtual pet” in operation 102 above can be achieved by fusing the first player character with a single first virtual pet currently included in the virtual scene, to form the second virtual pet when the virtual scene currently only includes the single first virtual pet of the first player character.

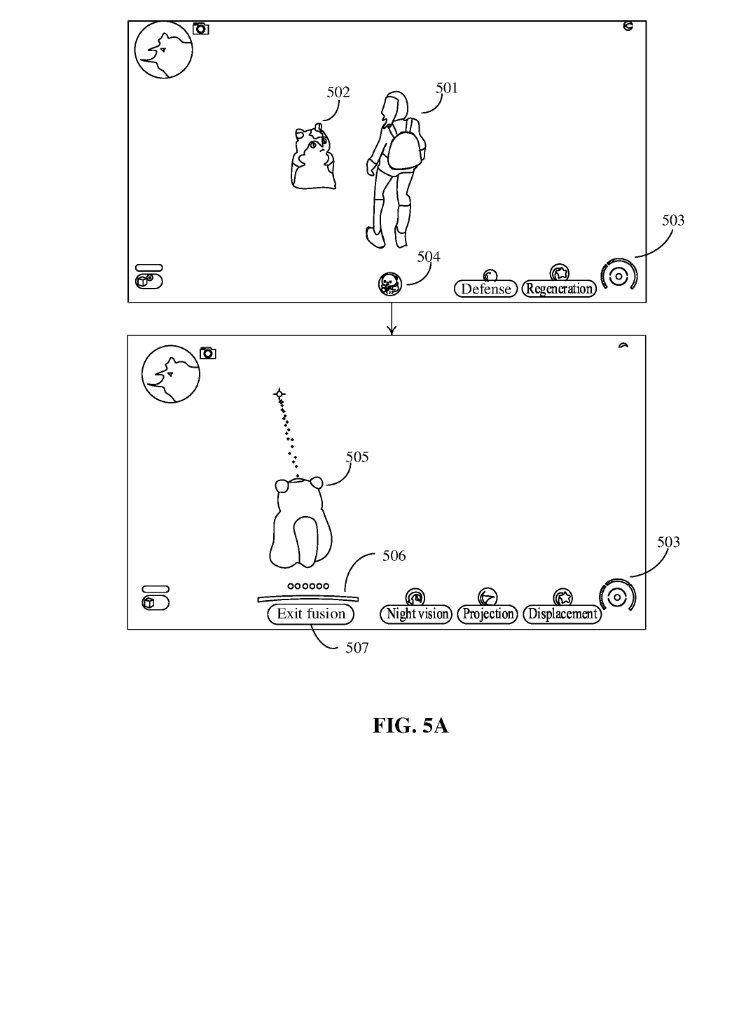

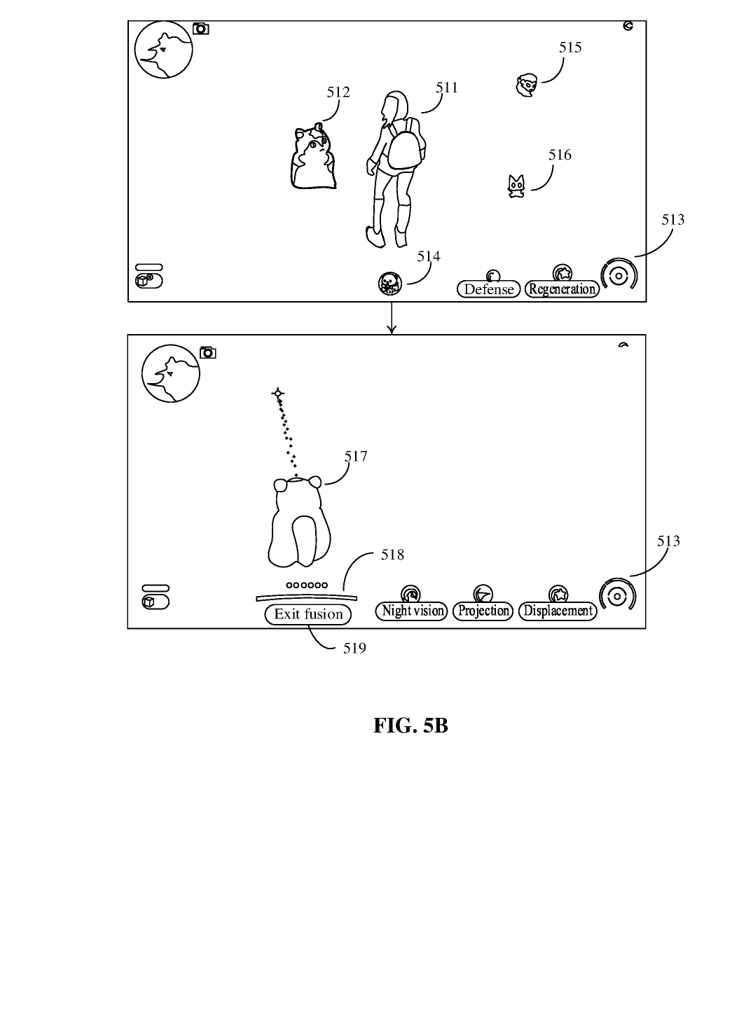

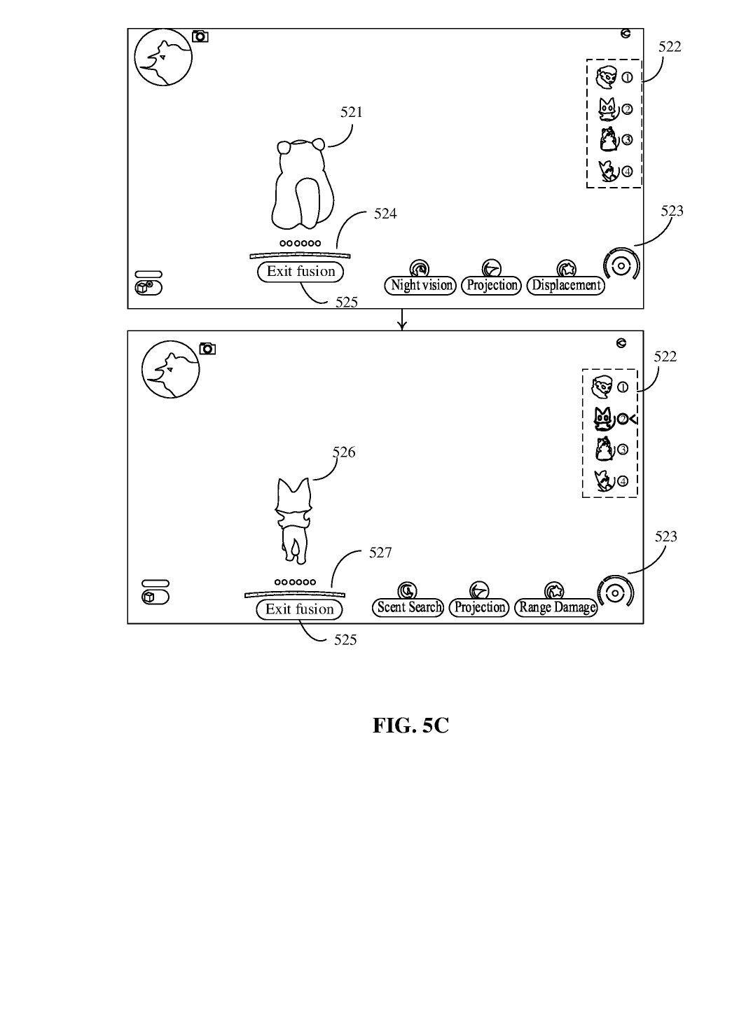

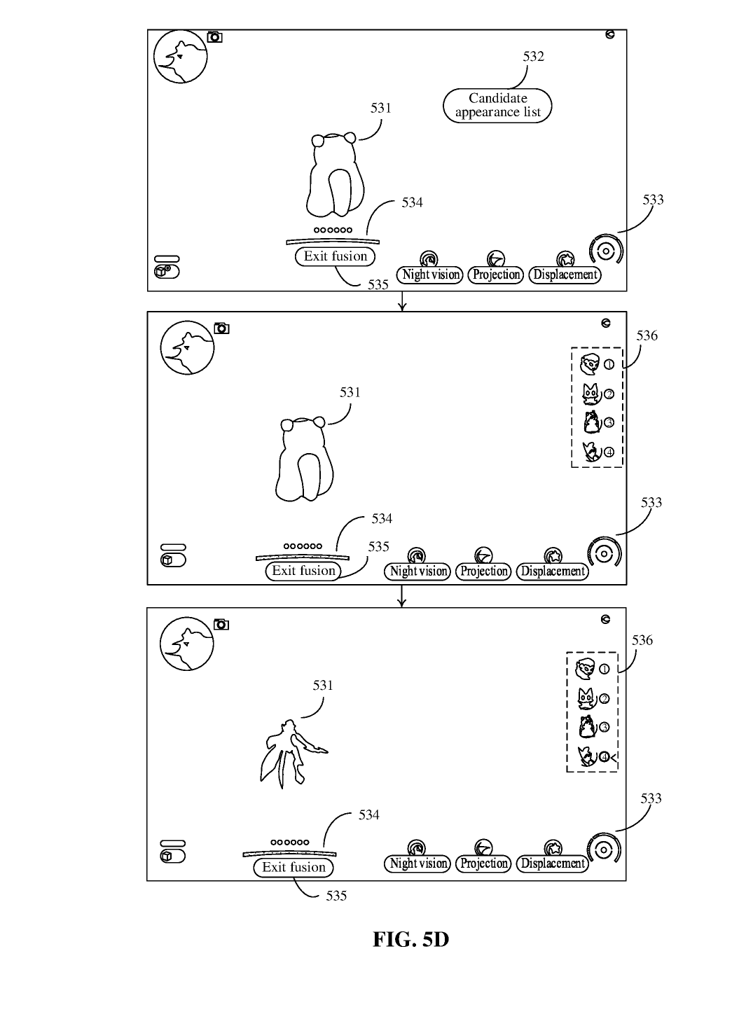

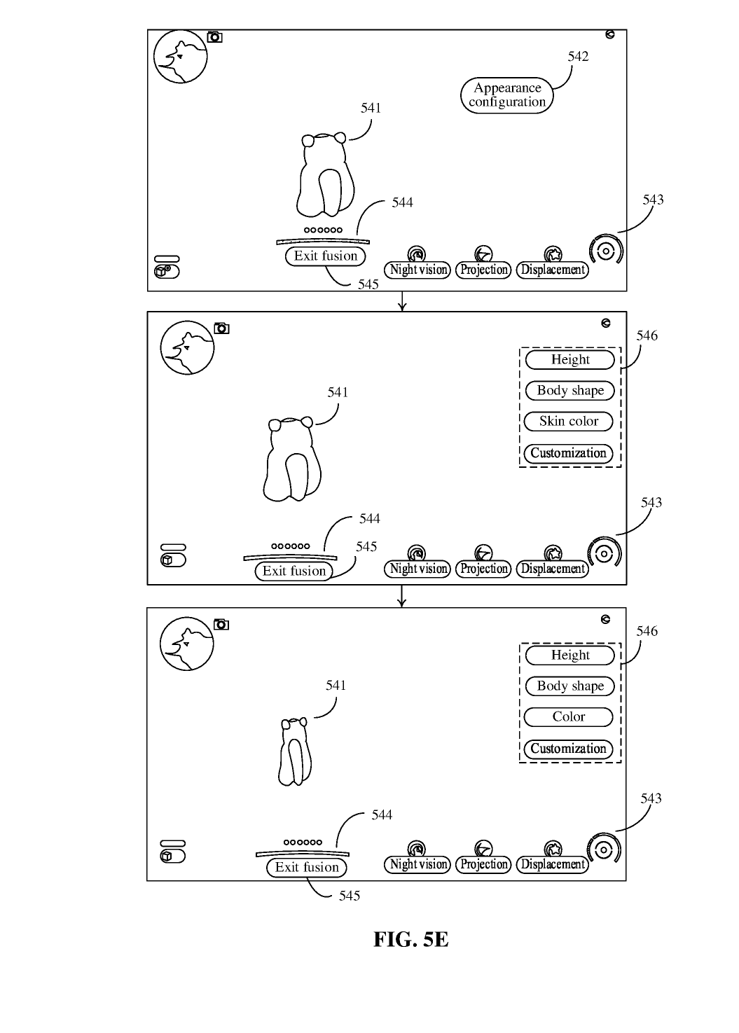

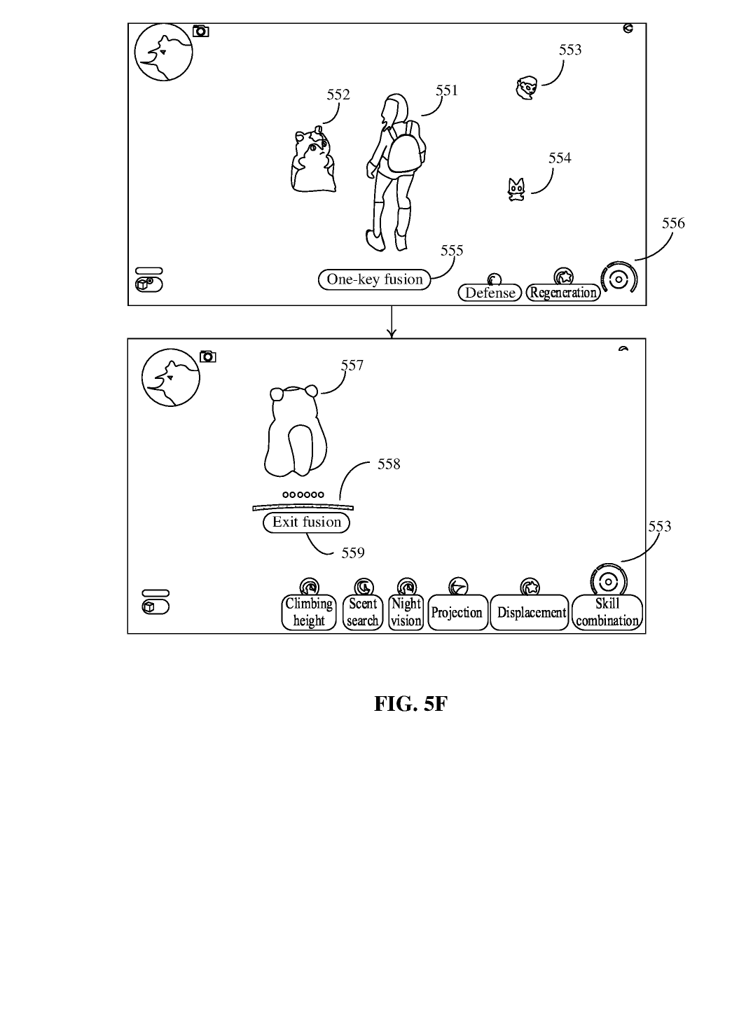

For example, referring to FIG. 5A, FIG. 5A is a fifth schematic diagram illustrating a virtual scene according to an embodiment of the present disclosure. As illustrated in the human-computer interaction interface at the top of FIG. 5A, a first player character 501, a first virtual pet 502, a skill combination 503, and a fusion control 504 are displayed. In response to a triggering operation for the fusion control 504, the first player character 501 and the first virtual pet 502 are fused, and then as illustrated in the human-computer interaction interface at the bottom of FIG. 5A, the fused second virtual pet 505 is displayed together with the attribute value 506 of the second virtual pet 505 and a disassembly control 507.

In some embodiments, when the virtual scene currently includes multiple first virtual pets of the first player character, “the first player character is fused with the at least one first virtual pet to form the second virtual pet” in operation 102 above can be achieved by fusing, in response to a selection operation for the multiple first virtual pets, the first player character with the at least one first virtual pet that has been selected, to form the second virtual pet (i.e., the first virtual pet can be manually selected by the player).

For example, referring to FIG. 5B, FIG. 5B is a sixth schematic diagram illustrating a virtual scene according to an embodiment of the present disclosure. As illustrated in the human-computer interaction interface at the top of FIG. 5A, a first player character 511, a first virtual pet 512, a skill combination 513, a fusion control 514, a first virtual pet 515 and a first virtual pet 516 are displayed. In response to the click operation for the first virtual pet 512, the first virtual pet 512 is selected as a target virtual pet. In response to a triggering operation for a fusion control 514, and then as illustrated in the human-computer interaction interface at the bottom of FIG. 5B, the fused second virtual pet 517 is displayed together with the attribute value 518 of the second virtual pet 517 and a disassembly control 519.

In other embodiments, when the number of first virtual pets of the first player character is multiple, “the first player character is fused with the at least one first virtual pet to form the second virtual pet” in operation 102 above can be achieved by fusing, in response to an automatic fusion triggering operation (e.g., a triggering for an automatic fusion control in the form of voice, motion-sensing, etc.), the first player character with the at least one first virtual pet screened from the multiple first virtual pets to form the second virtual pet. The screened virtual pet is obtained based on a descending order of a screening parameter, and the screening parameter is determined based on at least one of: a historical summoning frequency, a historical fusion frequency, a matching degree with a current environment in which the first player character is located and the interactive target, or an attribute value of the skill (e.g., attack power, defense power, speed, stamina, magic points, and/or the like) of the first virtual pet.

For example, the automatic fusion triggering operation can be a triggering operation for the automatic fusion control in the human-computer interaction interface. The automatic fusion triggering operation can also be a voice instruction received from the player through a microphone or another audio input apparatus. The received voice instruction is subjected to voice recognition, converting the received voice signal into text information or directly identifying instruction intent of the player, and then the automatic fusion of the first player character with the first virtual pet is triggered based on the parsed voice instruction. The automatic fusion triggering operation can also be a motion-sensing operation received from the player through a camera or another video input apparatus. The motion-sensing operation is parsed, and then the automatic fusion of the first player character with the first virtual pet is triggered based on the parsed motion-sensing operation.

In the embodiments of the present disclosure, when one first virtual pet of the first player character is included in the virtual scene, the fusion operation is performed directly, which makes the fusion operation more straightforward and simple, reducing learning cost for the player. The fusion may be performed by the player quickly, so as to deal with emergencies without having to select among multiple virtual pets. When multiple first virtual pets are included in the virtual scene, the fusion operation of the first player character with the first virtual pet is triggered through manual selection of the player or automatic selection of the system, which enables the player to select the suitable virtual pet for fusion based on different game environments and interactive targets to experience different fusion effects. Such dynamic changes can increase the fun and exploratory nature of the game. When the player is unable to make immediate decisions or needs to respond quickly, the system can automatically select a pet for fusion based on the preset screening parameter(s), thereby simplifying the operation process. The pet screened through the descending order is used by the player most frequently or is most adapted to the current environment, which helps optimize the player' selection. Screening based on a historical behavior and preference of the player provides a more personalized gaming experience. In summary, the design of this fusion mechanism improves strategy and dynamism for the game, while also providing an automated and personalized gaming experience, thereby enhancing the overall gaming experience for the player.

In some embodiments, there is one of the following relationships in morphology between at least one first virtual pet of the first player character and the second virtual pet. A size of at least one first virtual pet of the first player character is smaller than that of the second virtual pet, and a magnification factor of the size of the second virtual pet relative to the size of the first virtual pet characterizes a magnification factor of the skill of the first virtual pet used by the second virtual pet relative to the skill of the first virtual pet. A skin of the second virtual pet is the same as that of the first virtual pet. The skin of the second virtual pet is obtained by fusing a skin of the first player character with the skin of the first virtual pet, and a face of the second virtual pet is obtained by fusing a face of the first player character with a face of the first virtual pet so that the face of the second virtual pet has the facial characteristics of both the first player character and the first virtual pet. In this way, the other players can identify the second virtual pet corresponding to the first player character, and can enable the first player character to identify which pet it is currently fused with. When the first player character is fused with the multiple first virtual pets, the face and the skin of the second virtual pet change dynamically based on the first virtual pet to which the skill currently being used belongs, so that the face of the second virtual pet has the facial characteristics of the first player character, thereby achieving identifiability.

For example, the size of the second virtual pet is five times that of the first virtual pet. When the first virtual pet releases a displacement skill, the displacement skill can move 2 meters. Then, when the second virtual pet uses the skill of the first virtual pet, the displacement skill can move 10 meters. In case of the first player character fusing with the multiple first virtual pets, if the face and skin of the first virtual pet A have monkey characteristics and the face and skin of the first virtual pet B have fish characteristics, the face and skin of the second virtual pet will have monkey characteristics when the first player character uses the skill of the first virtual pet A in the forest; the face and skin of the second virtual pet will have fish characteristics when the first player character uses the skill of the first virtual pet B in the water.

In the embodiments of the present disclosure, the magnification factor of the size of the second virtual pet is matched with the magnification factor of the skill of the second virtual pet by differentiating an appearance of the fused second virtual pet from an appearance of the first virtual pet, so that an intuitive visual feedback is provided to the player, which makes the improvement of the pet's skill more visually reasonable. The skin of the second virtual pet is the same as the skin of the first virtual pet, maintaining the continuity and personalization of the character's appearance. The second virtual pet with a unique personality is created by fusing the skin and face of the first player character with the skin and face of the first virtual pet, and the face and skin of the second virtual pet change dynamically according to the first virtual pet to which the currently used skill belongs, which increases the appearance diversity and variability of the game. An appearance of the second virtual pet changes as the player switches different skills, making it easier for the player to recognize and remember the effects of different skills, enhancing the interactivity and personalization of the game, and providing the player with a richer and deeper gaming experience.

In some embodiments, after operation 102 above “the first player character is fused with the at least one first virtual pet to form the second virtual pet”, the following process may be performed. In response to meeting an update fusion condition, the second virtual pet is switched to a third virtual pet. The third virtual pet is obtained by fusing the first player character with at least one fourth virtual pet of the first player character.

Here, in case that multiple fourth virtual pets and multiple first virtual pets are used for fusion, the multiple first virtual pets used for fusion are at least partially different from the multiple fourth virtual pets used for fusion, for example, a second virtual pet that already has a lower matching degree (below a matching threshold) with the current environment and interactive target can be replaced.

For example, referring to FIG. 5C, FIG. 5C is a seventh schematic diagram illustrating a virtual scene according to an embodiment of the present disclosure. As illustrated in the human-computer interaction interface at the top of FIG. 5C, a second virtual pet 521, a pet list 522, a skill combination 523, an attribute value 524 of the second virtual pet 521 and a disassembly control 525 are displayed. The pet list 522 displays four fourth virtual pets, and the skill combination 523 displays the skill of the second virtual pet 521. In response to a triggering operation for the second one of virtual pets in the pet list 522, the second virtual pet 521 is switched to the third virtual pet 526 as illustrated in the human-computer interaction interface at the bottom of FIG. 5C. The third virtual pet 526 is obtained by fusing the player character with the second one of the virtual pets in the pet list 522. Simultaneously, the attribute value 527 of the third virtual pet 526 is displayed, and at this point, the skill combination 523 displays the skill of the third virtual pet 526.

Here, the above update fusion condition includes one of: receiving an update fusion operation, where the update fusion operation indicates to fusing the first player character with the at least one fourth virtual pet to replace fusing the first player character with at least one first virtual pet; or a matching degree of the at least one fourth virtual pet (with a skill or combat way) with the virtual scene and the interactive target being greater than a matching degree of the at least one first virtual pet (with a skill or combat way) with the virtual scene and the interactive target. That is, the first player character automatically fuses with a virtual pet that best matches the virtual scene (also referred to as the virtual environment) and the current interactive target, so as to ensure the interactive effect.

In some embodiments, an automatic update fusion mode can be set up in the game set-up system. For example, an automatic update fusion mode activation control can be set up in a game set-up interface of the human-computer interaction interface, and the automatic update fusion mode is started in response to a triggering operation for the automatic update fusion mode activation control. At this point, in response to meeting the update fusion condition, the player character can automatically fuse with the suitable virtual pet(s) without the need of intervention of the player, thereby enhancing operational efficiency and the level of intelligence.

In some embodiments, in response to an interactive triggering operation for the third virtual pet, the third virtual pet is controlled to release the skill of the fourth virtual pet. An interactive target of the skill of the fourth virtual pet includes at least one of: the virtual scene, the non-player character in the virtual scene, or the second player character.

With continued reference to FIG. 3A, the description will be provided following operation 102 above.

In operation 103, in response to an interactive triggering operation for the second virtual pet, the second virtual pet is controlled to release a skill of the first virtual pet, an interactive target of the skill includes at least one of: a non-player character in the virtual scene, or a second player character in the virtual scene. The second player character is different from the first player character.

In some embodiments, an attribute value of the skill of the first virtual pet released by the second virtual pet is the same as an attribute value when the first virtual pet is controlled to release the same skill. Alternatively, the attribute value of the skill of the first virtual pet released by the second virtual pet and the attribute value when the first virtual pet is controlled to release the same skill have a same gain factor. The gain factor is preset by the server or set by a first player account. For example, the gain factor could be dynamically set by the first player account during the game, or set before the game.

In some embodiments, “the second virtual pet is controlled to release the skill of the first virtual pet” in operation 103 above can be achieved by performing the following process. When the first player character fuses with the multiple first virtual pets to form the second virtual pet, the skill combination is released. The skill combination includes at least one skill belonging to each first virtual pet, and the skill combination is determined by approach 1 or approach 2.

Approach 1: Representative skill(s) of each first virtual pet is combined to obtain the skill combination.

Here, the representative skill(s) of the first virtual pet may be preset in the game set-up system or set by the first player character in the set-up interface.

Approach 2: Characteristics of multiple candidate skill combinations of the multiple first virtual pets are calculated by using a second machine learning model to obtain a usage probability of each candidate skill combination. Then, the candidate skill combination with a maximum usage probability is selected. The second machine learning model is trained by: predicting characteristics of multiple skill combination samples using the second machine learning model to obtain a predicted probability of each of the multiple skill combination samples; determining, using a loss function, a loss value based on a difference between the predicted probability of each of the multiple skill combination samples and an actual selected result label (1 for use and 0 for no use); and back-propagating the loss value using a back-propagation algorithm to update a parameter of the second machine learning model.

Here, the characteristic of the candidate skill combination can be the attribute value of the skill (e.g., attack power, defense power, speed, stamina, magic points, and/or the like), cooldown time, and so on.

For example, the second machine learning model may be an MLP, a CNN, a RNN, a VAE, a transformer, an LSTM, and a PPO, or the like. The loss function used to determine the loss value may be an MSE, a RMSE, a MAE, cross-entropy loss, or other loss functions.

For example, referring to FIG. 5F, FIG. 5F is a tenth schematic diagram illustrating a virtual scene according to an embodiment of the present disclosure. As illustrated in the human-computer interaction interface at the top of FIG. 5F, a first player character 551, a first virtual pet 552, a first virtual pet 553, a first virtual pet 554, a one-key fusion control 555 and a skill combination 556 are displayed. In response to a triggering operation for the one-key fusion control 555, the first player character 551, the first virtual pet 552, the first virtual pet 553 and the first virtual pet 554 are fused into the second virtual pet, and the fused second virtual pet 557 is displayed in the human-computer interaction interface at the bottom of FIG. 5F. An attribute value 558 of the second virtual pet 557 and a disassembly control 559 are displayed simultaneously. At this point, the skill combination 556 displays all skills of the second virtual pet 557, including the skill combination of the second virtual pet 557. The second virtual pet 557 can be controlled to release the skill combination in response to a triggering operation for the skill combination.

In some embodiments, when the first player character is fused with the first virtual pet to form the second virtual pet, “the second virtual pet is controlled to release the skill of the first virtual pet” in operation 103 above can be achieved by one of the following process. The skill list of the first virtual pet is displayed, and the second virtual pet is controlled to release the selected skill in response to a selection operation for the skill list. Alternatively, the second virtual pet is controlled to release the selected skill in response to a triggering operation for a specific skill of the first virtual pet.

For example, a triggering operation for the specific skill of the first virtual pet may be performed by a shortcut on a terminal device (such as a mouse or keyboard), or may be performed by a gesture shortcut, a voice instruction, a motion-sensing operation, etc.

For example, with continued reference to FIG. 5B, the skill combination 513 displays the skills of the first virtual pet. The second virtual pet is controlled to release a “displacement” skill in response to a triggering operation for the “displacement” skill.

In some embodiments, after performing “controlling the second virtual pet to release the skill of the first virtual pet” operation 103 above, the following process can be performed. In response to meeting a disassembly condition, the second virtual pet (or referred to as second virtual object) is decomposed into the first player character and the at least one first virtual pet (or referred to as first virtual object). The disassembly condition includes one of: receiving a disassembly triggering operation for the second virtual pet; a fusion duration of the first player character with the at least one first virtual pet reaching a preset duration; or the second virtual pet completing a preset task.

For example, with continued reference to FIG. 5B, in response to a triggering operation for the disassembly control 519, the second virtual pet 517 is decomposed into the first player character 511 and the first virtual pet 512.

In some embodiments, referring to FIG. 3C, FIG. 3C is a third flowchart illustrating a method for interactive processing in a virtual scene according to an embodiment of the present disclosure. The second virtual pet obtained by fusing the first player character with the at least one first virtual pet has a first appearance. Before performing the operation 103 “the second virtual pet is controlled to release the skill of the first virtual pet” above, operation 201 to operation 203 in FIG. 3C can be performed to switch the first appearance of the second virtual pet to a second appearance, as described below.

In operation 201, an appearance editing interface is displayed, and the appearance editing interface displays an appearance entry for configuring an appearance of the second virtual pet.

In some embodiments, after fusing the first player character with the at least one first virtual pet to obtain the second virtual pet with the first appearance, the appearance editing interface may be displayed, and the appearance editing interface displays the appearance entry for configuring the appearance of the second virtual pet.

In operation 202, in response to an appearance configuration operation triggered based on the appearance entry, the appearance of the second virtual pet is configured to a second appearance.

In some embodiments, the appearance configuration operation triggered based on the appearance entry can be implemented in the following way. A candidate appearance list is displayed in response to a triggering operation for the appearance entry, and the appearance configuration of the second virtual pet is implemented in response to a selection operation for the candidate appearance list. Alternatively, an appearance configuration menu is displayed in response to the triggering operation for the appearance entry, and the appearance configuration of the second virtual pet is implemented in response to a configuration operation for an appearance label in the appearance configuration menu.

In some embodiments, referring to FIG. 3D, FIG. 3D is a fourth flowchart illustrating a method for interactive processing in a virtual scene according to an embodiment of the present disclosure. Operation 202 above can be achieved by performing operation 2021 to operation 2022 of FIG. 3D, as described below.

In operation 2021, in response to a triggering operation for the appearance entry, an appearance selection interface is displayed, and the appearance selection interface displays at least one candidate appearance.

For example, referring to FIG. 5D, FIG. 5D is an eighth schematic diagram illustrating a virtual scene according to an embodiment of the present disclosure. As illustrated in the human-computer interaction interface at the top of FIG. 5D, a second virtual pet 531, a candidate appearance list 532, a skill combination 533, an attribute value 534 of the second virtual pet 531 and the disassembly control 535 are displayed. At this point, the second virtual pet 531 adopts the first appearance.

In operation 2022, in response to a selection operation for the second appearance among the at least one candidate appearance, the appearance of the second virtual pet is configured to the second appearance.

For example, with continued reference to FIG. 5D, in response to a triggering operation for the candidate appearance list 532 in the human-computer interaction interface at the top of FIG. 5D, the human-computer interaction interface in the middle of FIG. 5D is displayed. In the human-computer interaction interface in the middle of FIG. 5D, a candidate appearance menu 536 is displayed, and there are four virtual pet appearances in the candidate appearance menu 536. In response to a selection operation for the fourth virtual appearance in the candidate appearance menu 536, the second virtual pet 531 with the second appearance is displayed in the human-computer interaction interface at the bottom of FIG. 5D.

In other embodiments, referring to FIG. 3E, FIG. 3E is a fifth flowchart illustrating a method for interactive processing in a virtual scene according to an embodiment of the present disclosure. Operation 202 above can also be achieved by performing operation 2023 to operation 2024 of FIG. 3E, as described below.

In operation 2023, in response to a triggering operation for the appearance entry, an appearance configuration interface is displayed, and the appearance configuration interface displays at least one appearance label.

For example, referring to FIG. 5E, FIG. 5E is a ninth schematic diagram illustrating a virtual scene according to an embodiment of the present disclosure. As illustrated in the human-computer interaction interface at the top of FIG. 5E, a second virtual pet 541, an appearance configuration entry 542, a skill combination 543, an attribute value 544 of the second virtual pet 541 and a disassembly control 545 are displayed. At this point, the second virtual pet 541 adopts the first appearance. In response to a triggering operation for the appearance configuration entry 542, the human-computer interaction interface illustrated in the middle of FIG. 5E is displayed. The human-computer interaction interface illustrated in the middle of FIG. 5E displays a label menu 546, which can be used to customize a height, a body shape (such as fatness or thinness), a skin color, and other configurations of the second virtual pet 541.

In operation 2024, in response to a selection operation for a target appearance label, the appearance of the second virtual pet is configured to the second appearance generated based on the target appearance label.

For example, with continued reference to FIG. 5E, the second virtual pet 541 with the second appearance is displayed in the human-computer interaction interface at the bottom of FIG. 5E when the configuration is completed.

With continued reference to FIG. 3C, the description will be provided following operation 202 above.

In operation 203, in response to a confirmation operation for the second appearance, the second appearance is adopted as the appearance of the second virtual pet.

Here, the first appearance is an appearance of the first virtual pet, and the first appearance is different from the second appearance.

In the embodiments of the present disclosure, the player can customize the appearance of the second virtual pet through the appearance editing interface, thereby enhancing the personalization experience for the game. The player can select the color, the accessory, or the appearance according to their preferences, so as to create a unique pet appearance. The game encourages the player to invest more time and effort by allowing the player to customize the appearances of their pets, thereby enhancing their sense of participation and emotional bond with the game character. The appearance editing function can attract the attention of the player, increase the game's repeatability and diversity, significantly enhance the game's user experience and appeal, and at the same time provide the game developer with new market opportunities and technical challenges.

In some embodiments, referring to FIG. 3F, FIG. 3F is a sixth flowchart illustrating a method for interactive processing in a virtual scene according to an embodiment of the present disclosure. For the first player character, operation 301 to operation 302 of FIG. 3F can be performed, as described below.

In operation 301, in response to a transformation triggering operation for the first player character, or in response to the first player character meeting an automatic transformation condition, the first player character is transformed into a fifth virtual pet, and an appearance of the fifth virtual pet is the same or similar as an appearance of the first virtual pet.

In some embodiments, the transformation triggering operation for the first player character may be in response to a triggering operation for a transformation control in the human-computer interaction interface, to trigger the transformation of the first player character.

For example, the automatic transformation condition can include at least one of the following conditions. When the player completes a specific task or series of tasks, as a game reward, the player can transform into the fifth virtual pet, so as to obtain a new skill or ability. When the player enters a specific game environment or area, (such as a magic forest, an underwater world, or an alien planet) the player character automatically transforms into the fifth virtual pet to adapt to the new environment or unlock special abilities. When the player character meets a specific condition (such as collecting enough resources, owning a specific item, or achieving a specific accomplishment), the player character automatically transforms into the fifth virtual pet. When the player character reaches a certain level, the character may automatically transform into the fifth virtual pet as a reward for level-up and an enhancement of ability.

The embodiments of the present disclosure enable the player character to transform into the virtual pet. The design of the automatic transformation condition can increase the interactivity of the game and the player's engagement in the game, and can also serve as a game design mechanism to guide the player to explore the game world and complete tasks.

In operation 302, in response to an interactive triggering operation for the fifth virtual pet, the fifth virtual pet is controlled to release the skill of the first virtual pet, and the interactive target of the skill includes at least one of: the non-player character in the virtual scene or the second player character in the virtual scene, and the second player character is different from the first player character.

In summary, the embodiments of the present disclosure, in response to the fusion triggering operation for the first player character and at least one first virtual pet of the first player character, or in response to the first player character and the at least one first virtual pet of the first player character meeting an automatic fusion condition, the first player character is fused with the at least one first virtual pet to form the second virtual pet. In this way, the dynamic transformation from the player character to the fusion morphology is achieved through the fusion mechanism, which increases the diversity and dynamism of character changes. In response to the interactive triggering operation for the second virtual pet, the second virtual pet is controlled to release the skill of the first virtual pet, so as to interact with other player characters or the non-player character in the virtual scene, which allows the player to adjust a skill usage strategy for different enemies or environments, and release different skill combinations by fusing with different virtual pets, thereby increasing the adaptability and diversity of the interaction.

An exemplary application of the embodiments of the present disclosure in a game scene will be described below.

In the game scene, the interaction between the player character and the virtual pet can enhance the player's gaming experience during the interaction. In the related art, the interaction mode between the player character and the virtual pet is typically as follows. The virtual pet appears based on the player character, and the player can assign tasks to the virtual pet (such as finding items, exploring the map, fighting), and the virtual pet will complete the tasks based on an instruction and collaborate with the player to achieve the task objective. Alternatively, the player character can transform into the appearance of the virtual pet and interact in the virtual scene. However, this game interaction mode is too simplistic, lacking the deep physical or emotional interaction between the player character and the virtual pet, thereby affecting the immersion of the player character during the game.

The interactive processing method of the virtual scene provided by the embodiments of the present disclosure presents a new game interaction mode, which allows the player character to directly transform into the virtual pet in a certain way (not limited to transformation/fusion). Moreover, the player can control the virtual pet and directly use the skill of the virtual pet to interact with other player characters or non-player characters in the virtual environment.

For example, the player character may carry four virtual pets and form a team to adventure in a virtual world, with only one virtual pet following the player character on a field at the same time. In response to receiving a transformation instruction from the player character or a fusion instruction with the virtual pet, the player character enters a virtual mental space of the virtual pet, and the appearance of the player character changes from a human figure to the currently active virtual pet. That is, after the player character fuses with the virtual pet, the player character controls the pet by entering the virtual mental space of the virtual pet.

Here, the virtual mental space of each virtual pet can be specifically designed based on the characteristics of the virtual pet, including the skill controls of the virtual pet and movement controls for controlling the movement of the virtual pet. For example, for a virtual pet with a jumping ability to jump, a jump control is displayed; for a virtual pet with a flight ability to fly, a flight-related control is displayed.

For example, when the player character and the virtual pet are fused, it can be indicated that the player character has entered the virtual mental space of the virtual pet by adding specific filter effects to the human-computer interaction interface before the fusion, so that the display effect of the human-computer interaction interface after the fusion is inconsistent with that of the human-computer interaction interface before the fusion. That is, the virtual mental space of the virtual pet can be displayed in response to the fusion triggering operation for the player character with the virtual pet.

Here, the specific filter effect can be any of: blurring an edge of the human-computer interaction interface, changing the color of the current human-computer interaction interface (such as increasing saturation or contrast, or using a specific tone), adding dynamic effects of light and shadow (such as halos, shadows, or glows), setting the human-computer interaction interface as semi-transparent or fully transparent, or adding specific sound effects and background music (such as soft and dreamy melodies or subtle electronic sound effects).

In case that the player character fuses with multiple virtual pets, the mental space of the fused virtual pet can be a combination of the virtual mental spaces of multiple virtual pets. For example, in a skill combination of the fused virtual pets, the skill control related to the virtual mental space of each virtual pet can be displayed in separate zones.

For example, in response to the fusion operation of the player character with three virtual pets, the fused virtual pets are displayed. The three virtual pets are virtual pet 1, virtual pet 2, and virtual pet 3. In the skill combination of the fused virtual pets, area 1 is a control related to a virtual mental space of virtual pet 1, area 2 is a control related to a virtual mental space of virtual pet 2, and area 3 is a control related to a virtual mental space of virtual pet 3.

In fusion mode, the player character can directly control the virtual pet to engage in real-time combat in the current virtual scene. For example, the player character can control the current virtual pet to perform real-time movements, jumps, attacks, skill releases, or the like. The attacks initiated by releasing skills can have various effects (such as damage or control) on other units (such as player characters or non-player characters) in the virtual scene. At the same time, the skill of the virtual pet will also have various attributes, and different attributes will have different effects on the environment. For example, a skill with the ice attribute can create ice blocks on water, a skill with the fire attribute can burn vines, and a skill with the electricity attribute can charge a device. The player can switch any pet in the team to the currently controlled virtual pet at any time by using a switching instruction, so that the player character has different operational experiences and combat abilities by switching to a different virtual pet.

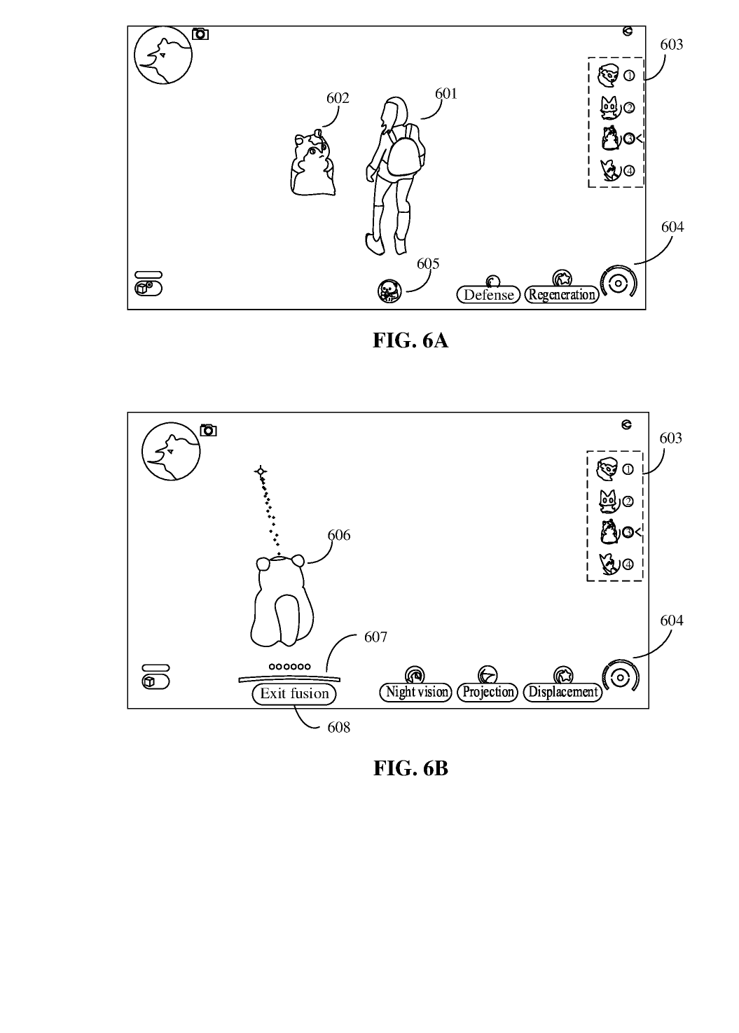

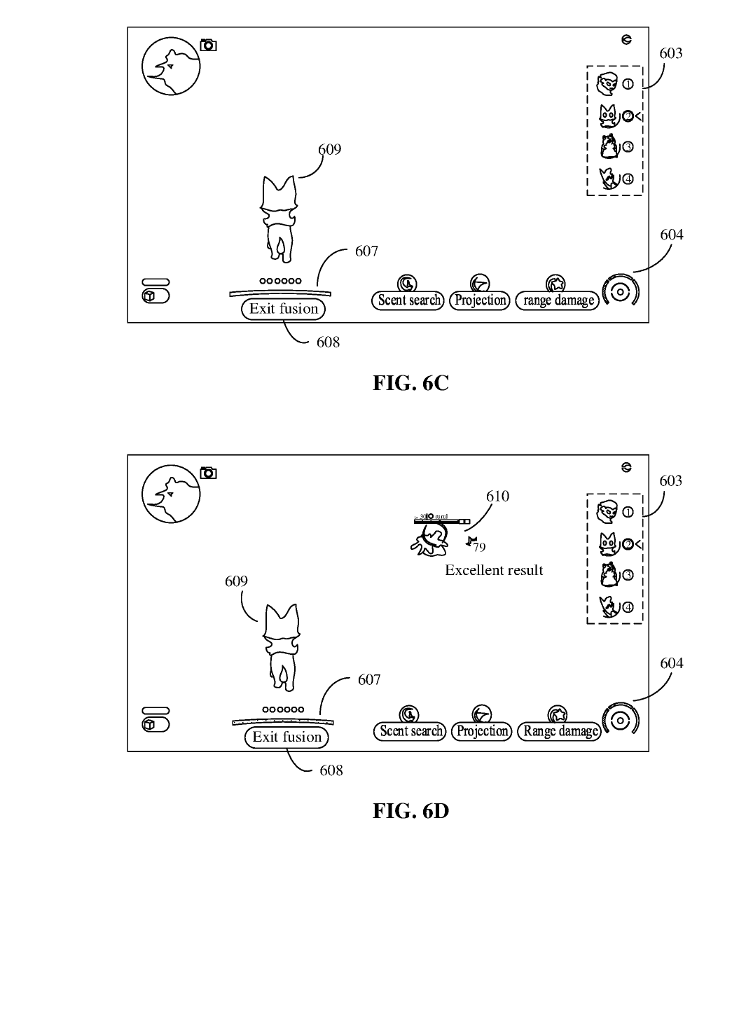

For example, referring to FIG. 6A, FIG. 6A is an eleventh schematic diagram illustrating a virtual scene according to an embodiment of the present disclosure. In the interface of FIG. 6A, a player character 601, a virtual pet 602, a pet list 603, a skill component 604 and a fusion control 605 are displayed. The virtual pet 602 is the third one of the virtual pets in pet list 603 and skill component 604 displays an original skill of the player character. The human-computer interaction interface of FIG. 6B is displayed in response to a triggering operation from the player for the fusion control 605.

Referring to FIG. 6B, FIG. 6B is a twelfth schematic diagram illustrating a virtual scene according to an embodiment of the present disclosure. As illustrated in FIG. 6B, in the human-computer interaction interface of FIG. 6B, a virtual pet 606 formed by fusing the player character 601 with the virtual pet 602, a pet attribute bar 607 and a disassembly control 608 are displayed, and skills of the virtual pet 602 are displayed in the skill component 604 simultaneously.

In case that the player character and the virtual pet fuse to obtain the fused virtual pet, in response to a switching operation from the player, a current virtual pet can be switched to any virtual pet in the pet list, and different pets have different operation experiences and combat abilities.

For example, referring to FIG. 6C, FIG. 6C is a thirteenth diagram illustrating a virtual scene according to an embodiment of the present disclosure. In response to a triggering operation from the player for the second virtual pet in the pet list 603, the virtual pet in the human-computer interaction interface is switched from the virtual pet 606 in FIG. 6B to a virtual pet 609. The virtual pet 609 has the same appearance as the second virtual pet in the pet list 603. At this point, skills of virtual pet 609 are displayed in the skill component 604.

After the player character becomes a virtual pet through transformation or fusion, the player character can directly control the virtual pet in real-time combat. For example, the player character can directly control the current virtual pet to perform real-time movements, jumps, attacks, skill releases, or the like. The attacks initiated by releasing skills can have various effects (such as damage or control) on other units (such as player characters or non-player characters) in the virtual scene.

For example, referring to FIG. 6D, FIG. 6D is a fourteenth schematic diagram illustrating a virtual scene according to an embodiment of the present disclosure. The player character can directly control the current virtual pet 609 to unleash a skill on a virtual object 610 in the current environment. A damage point inflicted on the virtual object 610 is displayed in the human-computer interaction interface.

The implementation process of the interactive method for the virtual scene provided by the embodiments of the present disclosure is described below. Firstly, the player character and the pet on the field are displayed in a game interface, and then the pet list is displayed, in which the pet on the field is marked. In response to the triggering operation from the player for the “fusion” control, the terminal captures a click event through an event listener, invokes a game server application programming interface (API) corresponding to a “fusion” component to obtain the fusion effects (including the skill attributes and the current position of the virtual pet) of the player character and virtual pet on the field, and performs scene rendering to generate a fusion interface, and switches the current display state of the interface to the fusion state.

Next, the player character is fused with the current character on the field, and the fused pet, together with its skills and combat value, is displayed. Here, the state of the position and combat value of the pet can be updated through geometric calculations and spatial data transfer. Then, the virtual pet(s) on the field is switched in response to the selection operation from the player for a virtual pet in the pet list, or in response to the triggering operation from the player character for a preset shortcut key. In response to detecting the switching operation from the player, the responsive interface is invoked to send the switching instruction to the server and render the virtual pet to be switched in real time on the game interface. Finally, when the player character with the virtual pet is in a fused state, the skill and combat value of the corresponding virtual pet are displayed in the human-computer interaction interface.

The interactive method for the virtual scene provided by the embodiments of the present disclosure can bring rich gameplay and a high degree of freedom to the game, while it can also enhance player engagement and the fun of the game. The following beneficial technical effects are specifically achieved. The player character can directly transform into the virtual pet in a certain way (not limited to transformation/fusion). Moreover, the player can control the virtual pet and directly use the skill of the virtual pet to interact with other player characters or non-player characters in the virtual environment, aiming to provide the player with a richer interactive experience. The player character can select different virtual pets for transformation or fusion, thereby increasing the diversity of the player character and the game strategy. A more diverse range of combat ways and skill combinations are provided, allowing the player to flexibly switch the pet based on a combat environment and an enemy type and adopt different tactical responses. The player can switch between pet morphology and normal morphology to manage resources (such as stamina, magic points, or the like) reasonably and use skill of the pet to restore resources when necessary.

The following continues to describe an example structure in which an interactive processing device for a virtual scene 455 provided by the embodiments of the present disclosure is implemented as software modules. In some embodiments, as illustrated in FIG. 2, the software modules in the interactive processing device for the virtual scene 455 stored in the memory 450 may include a scene display module 4551, a fusion processing module 4552, and a control processing module 4553.

The scene display module 4551 is configured to display the virtual scene in a human-computer interaction interface. The virtual scene includes a first player character.

The fusion processing module 4552 is configured to: in response to a fusion triggering operation for the first player character and at least one first virtual pet of the first player character, or in response to the first player character and the at least one first virtual pet of the first player character meeting an automatic fusion condition, fuse the first player character with the at least one first virtual pet to form a second virtual pet. The first player character is a player character controlled by the human-computer interaction interface.

The control processing module 4553 is configured to: in response to an interactive triggering operation for the second virtual pet, control the second virtual pet to release a skill of the first virtual pet. An interactive target of the skill includes at least one of: a non-player character in the virtual scene, or a second player character in the virtual scene, herein the second player character is different from the first player character.

In some embodiments, the fusion processing module 4552 is further configured to: display the first pet list, herein the first pet list includes the at least one first virtual pet of the first player character and skill information of the first virtual pet; in response to a selection operation for the first pet list, highlight the at least one first virtual pet that has been selected; in response to the fusion triggering operation for the first player character and the at least one first virtual pet that has been selected, fuse the first player character with the at least one first virtual pet that has been selected, to form the second virtual pet.

In some embodiments, when the number of first virtual pets in the first pet list is multiple, the multiple first virtual pets are sorted based on at least one of: a historical summoning frequency, a historical fusion frequency, a matching degree with at least one of: a current environment in which the first player character is located or the interactive target, or an attribute value of the skill of the first virtual pet.

In some embodiments, the matching degree is predicted by using a first machine learning model based on a characteristic of the first player character, a characteristic of the current environment in which the first player character is located, and a characteristic of the interactive target. The first machine learning model is trained by: calculating a predicted matching degree using the first machine learning model based on a characteristic of a sample player character, a characteristic of a current environment in which the sample player character is located, and a characteristic of an interactive target of the sample player character; and back-propagating a difference between the predicted matching degree and an actual interactive result label to update a parameter of the first machine learning model.

In some embodiments, the fusion processing module 4552 is further configured to: when the virtual scene currently only includes a single first virtual pet of the first player character, fuse the first player character with the single first virtual pet currently included in the virtual scene, to form the second virtual pet; when the virtual scene currently includes multiple first virtual pets of the first player character, fuse, in response to a selection operation for the multiple first virtual pets, the first player character with the at least one first virtual pet that has been selected, to form the second virtual pet; or when the number of first virtual pets of the first player character is multiple, fuse, in response to an automatic fusion triggering operation, the first player character with the at least one first virtual pet screened from the multiple first virtual pets to form the second virtual pet, herein the screened virtual pet is obtained based on a descending order of a screening parameter, and the screening parameter is determined based on at least one of: a historical summoning frequency, a historical fusion frequency, a matching degree with a current environment in which the first player character is located and the interactive target, or an attribute value of the skill of the first virtual pet.

In some embodiments, the automatic fusion condition includes one of: a matching degree of the at least one the first virtual pet with a current environment in which the first player character is located and the interactive target being greater than a matching degree of the first player character with the current environment in which the first player character is located and the interactive target; the at least one first virtual pet being a first pre-configured object for the interactive target, herein the first pre-configured object is a virtual pet that automatically fuses with the first player character when a distance between the first player character and the interactive target is less than a distance threshold; the at least one first virtual pet being a second pre-configured object for the current environment in which the first player character is located, herein the second pre-configured object is a virtual pet that automatically fuses with the first player character when the first player character is located in the current environment; or a skill of the first player character alone being not capable of implementing a preset interactive result with the interactive target, and the skill of the at least one first virtual pet being capable of implementing the preset interactive result with the interactive target.

In some embodiments, the fusion processing module 4552 is further configured to switch the second virtual pet to a third virtual pet in response to meeting an update fusion condition. The third virtual pet is obtained by fusing the first player character with at least one fourth virtual pet of the first player character. The update fusion condition includes one of: receiving an update fusion operation, herein the update fusion operation indicates fusing the first player character with the at least one fourth virtual pet; or a matching degree of the at least one fourth virtual pet with the virtual scene and the interactive target being greater than a matching degree of the at least one first virtual pet with the virtual scene and the interactive target.

In some embodiments, the control processing module 4553 is further configured to: in response to an interactive triggering operation for the third virtual pet, control the third virtual pet to release a skill of the fourth virtual pet, herein an interactive target of the skill of the fourth virtual pet includes at least one of: the virtual scene, the non-player character in the virtual scene, or the second player character.

In some embodiments, the control processing module 4553 is further configured to: in response to meeting a disassembly condition, decompose the second virtual pet into the first player character and the at least one first virtual pet, herein the disassembly condition includes one of: receiving a disassembly triggering operation for the second virtual pet; a fusion duration of the first player character with the at least one first virtual pet reaching a preset duration; or the second virtual pet completing a preset task.

In some embodiments, the control processing module 4553 is further configured to: transform the first player character into a fifth virtual pet in response to a transformation triggering operation for the first player character or in response to the first player character meeting an automatic transformation condition, herein an appearance of the fifth virtual pet is the same or similar as an appearance of the first virtual pet; and control the fifth virtual pet to release the skill of the first virtual pet in response to an interactive triggering operation for the fifth virtual pet, herein the interactive target of the skill includes at least one of: the non-player character in the virtual scene or the second player character in the virtual scene, and the second player character is different from the first player character.

In some embodiments, the fusion processing module 4552 is further configured to: before responding to the fusion triggering operation for the first player character and the at least one first virtual pet of the first player character, and when the virtual scene further includes the at least one first virtual pet of the first player character and the first player character has multiple first virtual pets, perform at least one of the following processes. That is, the fusion processing module is further configured to: display a second pet list, herein the second pet list includes the multiple first virtual pets belonging to the first player character; switch a first virtual pet following the first player character in the virtual scene to the first virtual pet that has been selected in response to a selection operation for the second pet list. The fusion processing module is further configured to: switch a first virtual pet currently following the first player character to another first virtual pet of the first virtual player in response to a switching operation. Here, the other first virtual pet is the first virtual pet with a highest screening parameter among the multiple first virtual pets, and the screening parameter is determined based on at least one of: a historical summoning frequency, a historical fusion frequency, a matching degree with a current environment in which the first player character is located and the interactive target, or an attribute value of the skill of the first virtual pet.

In some embodiments, the control processing module 4553 is further configured to: release a skill combination when the first player character fuses with multiple first virtual pets to form the second virtual pet. The skill combination includes at least one skill belonging to each first virtual pet, and the skill combination is determined by combining a representative skill of each first virtual pet or is determined by calculating characteristics of multiple candidate skill combinations of the multiple first virtual pets using a second machine learning model to obtain a usage probability of each candidate skill combination and selecting the candidate skill combination with a maximum usage probability. The second machine learning model is trained by: predicting characteristics of multiple skill combination samples using the second machine learning model to obtain a predicted probability of each of the multiple skill combination samples; and back-propagating a difference between the predicted probability of each of the plurality of skill combination samples and an actual selected result label to update a parameter of the second machine learning model.

In some embodiments, the control processing module 4553 is further configured to: when the first player character is fused with the first virtual pet to form the second virtual pet, display a skill list of the first virtual pet, and control the second virtual pet to release a selected skill in response to a selection operation for the skill list. Alternatively, the control processing module 4553 is further configured to: when the first player character is fused with the first virtual pet to form the second virtual pet, control the second virtual pet to release a selected skill in response to a triggering operation for a specific skill of the first virtual pet.

An embodiment of the present disclosure provides a computer program product. The computer program product includes a computer program or computer-executable instructions. The computer program or the computer-executable instructions are stored in a computer-readable storage medium. A processor of an electronic device reads the computer-executable instructions from the computer-readable storage medium, and the processor executes the computer-executable instructions, to cause the electronic device to implement the method for interactive processing in the virtual scene described in the embodiments of the present disclosure.

An embodiment of the present disclosure provides a computer-readable storage medium having sored computer-executable instructions or a computer program therein. The computer program or the computer-executable instructions, when executed by a processor, cause the processor to implement the method for interactive processing in the virtual scene provided by the embodiments of the present disclosure, such as the method for r interactive processing in the virtual scene illustrated in any of FIG. 3A.

In some embodiments, the computer-readable storage medium may be a memory such as a random access memory (RAM), a read-only memory (ROM), a flash memory, a magnetic surface memory, an optical disk, or a compact disc read-only memory (CD-ROM), or may be various devices including one or any combination of the above-mentioned memories.

In some embodiments, the computer-executable instructions may be written in a form of a program, software, a software module, a script, or code in any form of programming language (including compiled or interpretive language, or declarative or procedural language), and the computer-executable instructions may be deployed in any form, including being deployed as an independent program or being deployed as a module, component, subroutine, or another unit suitable for use in a computing environment.

In an example, the computer-executable instructions may but may not necessarily correspond to a file in a file system, and may be stored in a part of the file for storing other programs or data, for example, stored in one or more scripts in a hyper text markup language (HTML) document, stored in a single file specially for the discussed program, or stored in multiple collaborative files (for example, files storing one or more modules, a subroutine, or a code part).

In an example, the computer-executable instructions may be deployed to be executed on one electronic device, or on multiple electronic devices located at one location, or on multiple electronic devices distributed at multiple locations and connected by a communication network.

An embodiment of the present disclosure provides a method for interactive processing in a virtual scene, which includes the following operations.

The virtual scene is displayed in a human-computer interaction interface, and the virtual scene includes a first player character.

In response to a fusion triggering operation for the first player character and at least one first virtual pet of the first player character, or in response to the first player character and the at least one first virtual pet of the first player character meeting an automatic fusion condition, the first player character is fused with the at least one first virtual pet to form a second virtual pet, and the first player character is a player character controlled by the human-computer interaction interface.

In response to an interactive triggering operation for the second virtual pet, the second virtual pet is controlled to release a skill of the first virtual pet, an interactive target of the skill includes at least one of: a non-player character in the virtual scene, or a second player character in the virtual scene, and the second player character is different from the first player character.

In the above solution, in response to a transformation triggering operation for the first player character or in response to the first player character meeting an automatic transformation condition, the first player character is transformed into a fifth virtual pet, and an appearance of the fifth virtual pet is the same as or similar to an appearance of the first virtual pet.

In response to an interactive triggering operation for the fifth virtual pet, the fifth virtual pet is controlled to release the skill of the first virtual pet, and the interactive target of the skill includes at least one of: the non-player character in the virtual scene or the second player character in the virtual scene, and the second player character is different from the first player character.

In the above solution, before responding to the fusion triggering operation for the first player character and the at least one first virtual pet of the first player character, and when the virtual scene further includes the at least one first virtual pet of the first player character and the first player character has multiple first virtual pets, the method further includes the following operations.

At least one of the following processes is performed.

A second pet list is displayed, and the second pet list includes the multiple first virtual pets belonging to the first player character. In response to a selection operation for the second pet list, a first virtual pet following the first player character in the virtual scene is switched to the first virtual pet that has been selected.

In response to a switching operation, a first virtual pet currently following the first player character is switched to another first virtual pet of the first virtual player. The other first virtual pet is the first virtual pet with a highest screening parameter among the multiple first virtual pets, and the screening parameter is determined based on at least one of: a historical summoning frequency, a historical fusion frequency, a matching degree with a current environment in which the first player character is located and the interactive target, or an attribute value of the skill of the first virtual pet.

In the above solution, there is at least one of the following relationships in morphology between at least one first virtual pet of the first player character and the second virtual pet.

A size of at least one first virtual pet of the first player character is smaller than that of the second virtual pet. A magnification factor of the size of the second virtual pet relative to the size of the first virtual pet characterizes a magnification factor of the skill of the first virtual pet used by the second virtual pet relative to the skill of the first virtual pet used by the first virtual pet.

A skin of the second virtual pet is the same as a skin of the first virtual pet.

The skin of the second virtual pet is obtained by fusing a skin of the first player character with the skin of the first virtual pet, and a face of the second virtual pet is obtained by fusing a face of the first player character with a face of the first virtual pet.

When the first player character is fused with multiple first virtual pets, the face and the skin of the second virtual pet change dynamically based on the first virtual pet to which the skill currently being used belongs.

In the above solution, controlling the second virtual pet to release the skill of the first virtual pet includes the following operations.

When the first player character fuses with multiple first virtual pets to form the second virtual pet, a skill combination is released. The skill combination includes at least one skill belonging to each first virtual pet, and the skill combination is determined by:

combining a representative skill of each first virtual pet; or

calculating characteristics of multiple candidate skill combinations of the multiple first virtual pets using a second machine learning model to obtain a usage probability of each candidate skill combination and selecting the candidate skill combination with a maximum usage probability. The second machine learning model is trained by:

predicting characteristics of multiple skill combination samples using the second machine learning model to obtain a predicted probability of each of the multiple skill combination samples; and back-propagating a difference between the predicted probability of each of the plurality of skill combination samples and an actual selected result label to update a parameter of the second machine learning model.

In the above solution, controlling the second virtual pet to release the skill of the first virtual pet includes the following operations.

When the first player character is fused with the first virtual pet to form the second virtual pet, one of the following processes is performed.

A skill list of the first virtual pet is displayed, and in response to a selection operation for the skill list, the second virtual pet is controlled to release a selected skill.

In response to a triggering operation for a specific skill of the first virtual pet, the second virtual pet is controlled to release a selected skill.

In the above solution, the attribute value of the skill of the first virtual pet released by the second virtual pet is the same as an attribute value of the skill of the first virtual pet released by the first virtual pet. Alternatively, the attribute value of the skill of the first virtual pet released by the second virtual pet and the attribute value of the skill of the first virtual pet released by the first virtual pet have a same gain factor. The gain factor is preset by the server or set by a first player account.

An embodiment of the present disclosure provides a device for interactive processing in a virtual scene, which includes a scene display module, a fusion processing module and a control processing module.

The scene display module is configured to display the virtual scene in a human-computer interaction interface. The virtual scene includes a first player character.

The fusion processing module is configured to: in response to a fusion triggering operation for the first player character and at least one first virtual pet of the first player character, or in response to the first player character and the at least one first virtual pet of the first player character meeting an automatic fusion condition, fuse the first player character with the at least one first virtual pet to form a second virtual pet. The first player character is a player character controlled by the human-computer interaction interface.

The control module is configured to: in response to an interactive triggering operation for the second virtual pet, control the second virtual pet to release a skill of the first virtual pet. An interactive target of the skill includes at least one of: a non-player character in the virtual scene, or a second player character in the virtual scene, and the second player character is different from the first player character.

An embodiments of the present disclosure provide an electronic device, which includes a memory and a processor.

The memory is configured to store computer-executable instructions.

The processor is configured to execute the computer-executable instructions stored in the memory, to implement the method for interactive processing in a virtual scene provided by the embodiments of the present disclosure.

An embodiment of the present disclosure provides a computer-readable storage medium. The computer-readable storage medium is configured to store computer programs or computer-executable instructions. The computer programs or the computer-executable instructions, when executed by a processor, implement the method for interactive processing in a virtual scene provided by the embodiments of the present disclosure.

An embodiment of the present disclosure provides a computer program product. The computer program product includes computer programs or computer-executable instructions. The computer program or the computer-executable instructions, when executed by a processor, implement the method for interactive processing in a virtual scene provided by the embodiments of the present disclosure.

The embodiments of the present disclosure have the following beneficial effects.

In summary, the embodiments of the present disclosure, in response to the fusion triggering operation for the first player character and at least one first virtual pet of the first player character, or in response to the first player character and the at least one first virtual pet of the first player character meeting an automatic fusion condition, the first player character is fused with the at least one first virtual pet to form the second virtual pet. In this way, the dynamic transformation from the player character to the fusion morphology is achieved through the fusion mechanism, which increases the diversity and dynamism of character changes. In response to the interactive triggering operation for the second virtual pet, the second virtual pet is controlled to release the skill of the first virtual pet, so as to interact with other player characters or the non-player character in the virtual scene, which allows the player to adjust a skill usage strategy for different enemies or environments, and release different skill combinations by fusing with different virtual pets, thereby increasing the adaptability and diversity of the interaction.

The above is only the embodiments of the present disclosure and not intended to limit the scope of protection of the present disclosure. Any modification, equivalent replacement, improvement, and the like made within the spirit and scope of the present disclosure fall within the protection scope of the present disclosure.

1. A method for interactive processing in a virtual scene, the method comprising:
displaying the virtual scene in a human-computer interaction interface, wherein the virtual scene comprises a first player character;
in response to a fusion triggering operation for the first player character and at least one first virtual pet of the first player character, or in response to the first player character and the at least one first virtual pet of the first player character meeting an automatic fusion condition, fusing the first player character with the at least one first virtual pet to form a second virtual pet, wherein the first player character is a player character controlled by the human-computer interaction interface; and
in response to an interactive triggering operation for the second virtual pet, controlling the second virtual pet to release a skill of the first virtual pet, wherein an interactive target of the skill comprises at least one of: a non-player character in the virtual scene or a second player character in the virtual scene, and the second player character is different from the first player character.

2. The method of claim 1, wherein in response to the fusion triggering operation for the first player character and the at least one first virtual pet of the first player character, fusing the first player character with the at least one first virtual pet to form the second virtual pet comprises:
displaying a first pet list, wherein the first pet list comprises: the at least one first virtual pet of the first player character and skill information of the first virtual pet;
in response to a selection operation for the first pet list, highlighting the at least one first virtual pet that has been selected; and
in response to the fusion triggering operation for the first player character and the at least one first virtual pet that has been selected, fusing the first player character with the at least one first virtual pet that has been selected, to form the second virtual pet.

3. The method of claim 2, wherein
when the first pet list comprises a plurality of first virtual pets, the plurality of first virtual pets are sorted based on at least one of:
a historical summoning frequency,
a historical fusion frequency,
a matching degree with at least one of: a current environment in which the first player character is located or the interactive target, or
an attribute value of the skill of the first virtual pet.

4. The method of claim 3, wherein
the matching degree is predicted by using a first machine learning model based on a characteristic of the first player character, a characteristic of the current environment in which the first player character is located, and a characteristic of the interactive target,
wherein the first machine learning model is trained by:
calculating a predicted matching degree using the first machine learning model based on a characteristic of a sample player character, a characteristic of a current environment in which the sample player character is located, and a characteristic of an interactive target of the sample player character; and
back-propagating a difference between the predicted matching degree and an actual interactive result label to update a parameter of the first machine learning model.

5. The method of claim 1, wherein fusing the first player character with the at least one first virtual pet to form the second virtual pet comprises:
when the virtual scene currently only comprises a single first virtual pet of the first player character, fusing the first player character with the single first virtual pet currently comprised in the virtual scene, to form the second virtual pet;
when the virtual scene currently comprises a plurality of first virtual pets of the first player character, fusing, in response to a selection operation for the plurality of first virtual pets, the first player character with the at least one first virtual pet that has been selected, to form the second virtual pet;
when a number of first virtual pets of the first player character is multiple, fusing, in response to an automatic fusion triggering operation, the first player character with the at least one first virtual pet screened from the plurality of first virtual pets to form the second virtual pet, wherein the screened virtual pet is obtained based on a descending order of a screening parameter, and the screening parameter is determined based on at least one of: a historical summoning frequency, a historical fusion frequency, a matching degree with a current environment in which the first player character is located and the interactive target, or an attribute value of the skill of the first virtual pet.

6. The method of claim 1, wherein the automatic fusion condition comprises one of:
a matching degree of the at least one the first virtual pet with a current environment in which the first player character is located and the interactive target being greater than a matching degree of the first player character with the current environment and the interactive target;
the at least one first virtual pet being a first pre-configured object for the interactive target, wherein the first pre-configured object is a virtual pet that automatically fuses with the first player character when a distance between the first player character and the interactive target is less than a distance threshold;
the at least one first virtual pet being a second pre-configured object for the current environment in which the first player character is located, wherein the second pre-configured object is a virtual pet that automatically fuses with the first player character when the first player character is located in the current environment; or
a skill of the first player character alone being not capable of implementing a preset interactive result with the interactive target, and the skill of the at least one first virtual pet being capable of implementing the preset interactive result with the interactive target.

7. The method of claim 1, wherein after fusing the first player character and the at least one first virtual pet to form the second virtual pet, the method further comprises:
in response to meeting an update fusion condition, switching the second virtual pet to a third virtual pet, wherein the third virtual pet is obtained by fusing the first player character with at least one fourth virtual pet of the first player character,
wherein the update fusion condition comprises one of:
receiving an update fusion operation, wherein the update fusion operation indicates fusing the first player character with the at least one fourth virtual pet; or
a matching degree of the at least one fourth virtual pet with the virtual scene and the interactive target being greater than a matching degree of the at least one first virtual pet with the virtual scene and the interactive target.

8. The method of claim 7, further comprising:
in response to an interactive triggering operation for the third virtual pet, controlling the third virtual pet to release a skill of the fourth virtual pet, wherein an interactive target of the skill of the fourth virtual pet comprises at least one of: the virtual scene, the non-player character in the virtual scene, or the second player character.

9. The method of claim 1, wherein after controlling the second virtual pet to release the skill of the first virtual pet, the method further comprises:
in response to meeting a disassembly condition, decomposing the second virtual pet into the first player character and the at least one first virtual pet, wherein the disassembly condition comprises one of:
receiving a disassembly triggering operation for the second virtual pet;
a fusion duration of the first player character with the at least one first virtual pet reaching a preset duration; or
the second virtual pet completing a preset task.

10. The method of claim 1, wherein the virtual scene comprises the at least one first virtual pet of the first player character, and the first player character has a plurality of first virtual pets,
before responding to the fusion triggering operation for the first player character and the at least one first virtual pet of the first player character, the method further comprises at least one of:
displaying a second pet list comprising the plurality of first virtual pets belonging to the first player character, and in response to a selection operation for the second pet list, switching a first virtual pet following the first player character in the virtual scene to the first virtual pet that has been selected; or
in response to a switching operation, switching a first virtual pet following the first player character to another first virtual pet of the first player character, wherein the other first virtual pet is a first virtual pet with a highest screening parameter among the plurality of first virtual pets, and the screening parameter is determined based on at least one of: a historical summoning frequency, a historical fusion frequency, a matching degree with a current environment in which the first player character is located and the interactive target, or an attribute value of the skill of the first virtual pet.

11. The method of claim 1, wherein
a size of the at least one first virtual pet of the first player character is smaller than a size of the second virtual pet, wherein a magnification factor of the size of the second virtual pet relative to the size of the first virtual pet characterizes a magnification factor of the skill of the first virtual pet used by the second virtual pet relative to the skill of the first virtual pet used by the first virtual pet;
a skin of the second virtual pet is the same as a skin of the first virtual pet;
the skin of the second virtual pet is obtained by fusing a skin of the first player character with the skin of the first virtual pet, and a face of the second virtual pet is obtained by fusing a face of the first player character with a face of the first virtual pet; or
when fusing the first player character with a plurality of first virtual pets, the face and the skin of the second virtual pet change dynamically based on a first virtual pet to which a skill currently being used belongs.

12. The method of claim 1, wherein controlling the second virtual pet to release the skill of the first virtual pet comprises:
in response to the first player character fusing with a plurality of first virtual pets to form the second virtual pet, releasing a skill combination, wherein the skill combination comprises at least one skill belonging to each of the plurality of first virtual pets.

13. The method of claim 12, wherein
the skill combination is determined by combining a representative skill of each of the plurality of first virtual pets; or
the skill combination is determined by: calculating characteristics of a plurality of candidate skill combinations of the plurality of first virtual pets using a second machine learning model to obtain a usage probability of each of the plurality of candidate skill combinations, and selecting a candidate skill combination with a maximum usage probability as the skill combination.

14. The method of claim 13, wherein the second machine learning model is trained by:
predicting characteristics of a plurality of skill combination samples using the second machine learning model to obtain a predicted probability of each of the plurality of skill combination samples; and
back-propagating a difference between the predicted probability of each of the plurality of skill combination samples and an actual selected result label to update a parameter of the second machine learning model.

15. The method of claim 1, wherein controlling the second virtual pet to release the skill of the first virtual pet comprises:
when the first player character is fused with a single first virtual pet to form the second virtual pet, displaying a skill list of the first virtual pet, and controlling the second virtual pet to release a selected skill in response to a selection operation for the skill list.

16. The method of claim 1, wherein controlling the second virtual pet to release the skill of the first virtual pet comprises:
when the first player character is fused with a single first virtual pet to form the second virtual pet, controlling the second virtual pet to release a selected skill in response to a triggering operation for a specific skill of the first virtual pet.

17. The method of claim 1, wherein an attribute value of the skill of the first virtual pet released by the second virtual pet is the same as an attribute value of the skill of the first virtual pet released by the first virtual pet.

18. The method of claim 1, wherein an attribute value of the skill of the first virtual pet released by the second virtual pet and an attribute value of the skill of the first virtual pet released by the first virtual pet have a same gain factor, wherein the gain factor is preset by a server or set by a first player account.

19. A device for interactive processing in a virtual scene, the device comprising:
a memory, configured to store computer-executable instructions;
a processor, configured to execute the computer-executable instructions stored in the memory, to cause the device to:
display the virtual scene in a human-computer interaction interface, wherein the virtual scene comprises a first player character;
in response to a fusion triggering operation for the first player character and at least one first virtual pet of the first player character, or in response to the first player character and the at least one first virtual pet of the first player character meeting an automatic fusion condition, fuse the first player character with the at least one first virtual pet to form a second virtual pet, wherein the first player character is a player character controlled by the human-computer interaction interface; and
in response to an interactive triggering operation for the second virtual pet, control the second virtual pet to release a skill of the first virtual pet, wherein an interactive target of the skill comprises at least one of: a non-player character in the virtual scene or a second player character in the virtual scene, wherein the second player character is different from the first player character.

20. A non-transitory computer-readable storage medium, configured to store a computer program that causes a processor to perform a method for interactive processing in a virtual scene, comprising:
displaying the virtual scene in a human-computer interaction interface, wherein the virtual scene comprises a first player character;
in response to a fusion triggering operation for the first player character and at least one first virtual pet of the first player character, or in response to the first player character and the at least one first virtual pet of the first player character meeting an automatic fusion condition, fusing the first player character with the at least one first virtual pet to form a second virtual pet, wherein the first player character is a player character controlled by the human-computer interaction interface; and
in response to an interactive triggering operation for the second virtual pet, controlling the second virtual pet to release a skill of the first virtual pet, wherein an interactive target of the skill comprises at least one of: a non-player character in the virtual scene or a second player character in the virtual scene, and the second player character is different from the first player character.
